(19) United States
(12) Patent Application Publication
(10) Pub. No.: US 2025/0193424 A1
(43) Pub. Date: Jun. 12, 2025

(54) BIDIRECTIONAL BACKPROPAGATION AUTOENCODING NETWORKS FOR IMAGE COMPRESSION AND DENOISING

(71) Applicant: University of Southern California, Los Angeles, CA (US)

(72) Inventors: Bart KOSKO, Los Angeles, CA (US); Olaoluwa ADIGUN, Los Angeles, CA (US)

(73) Assignee: University of Southern California, Los Angeles, CA (US)

(21) Appl. No.: 18/979,324

(22) Filed: Dec. 12, 2024

Related U.S. Application Data
(60) Provisional application No. 63/609,007, filed on Dec. 12, 2023.

(51) Int. Cl. H04N 19/42; G06T 5/60; G06T 5/70

(52) U.S. Cl. CPC H04N 19/42; G06T 5/60; G06T 5/70; G06T 2207/20081; G06T 2207/20084

(57) ABSTRACT

A bidirectional autoencoder learns or approximates an identity mapping as it trains a single network with a version of the new bidirectional backpropagation algorithm. Ordinary unidirectional autoencoders find many uses in image processing and in large language models. But they use separate networks for encoding and decoding. Bidirectional autoencoders use the same synaptic weights for encoding and decoding. The forward pass encodes while the backward pass decodes. Bidirectional autoencoders improved network performance and significantly reduced memory usage and used fewer parameters. Simulations compared unidirectional with bidirectional autoencoders for image compression and denoising. The models trained on the MNIST handwritten-digit and CIFAR-10 image datasets. The performance measures were the peak signal-to-noise ratio and the index of structural similarity. Bidirectional autoencoders outperformed unidirectional autoencoders and still reduced the number of trainable synaptic parameters by about 50%.

### CROSS-REFERENCE TO RELATED APPLICATIONS

This application claims the benefit of U.S. provisional application Ser. No. 63/609,007 filed Dec. 12, 2023, the disclosure of which is hereby incorporated in its entirety by reference herein.

### TECHNICAL FIELD

In at least one aspect, the present invention relates to autoencoding for compressing and denoising images and text and other forms of data. In another aspect, a method related to autoencoding for generating images, text, and other forms of data is provided.

### BACKGROUND

Ordinary unidirectional AEs use separate networks for encoding and decoding. AE networks themselves learn or approximate identity mappings from unlabeled data or patterns. AEs can compress or summarize patterns or text. This lets them generate new patterns from old patterns. They can combine with large language models (LLMs) such as chat-AI GPTs to improve the performance of LLMs [1]-[3]. AEs also apply to a wide range of problems in data compression or dimension reduction [4]-[6], image denoising [7]-[11], feature extraction [12], anomaly detection [13]-[16], collaborative filtering [17], [18], and sentiment analysis [19]-[21].

Variational autoencoders (VAEs) build on traditional AEs by introducing probabilistic representations to model the data distribution more effectively. VAEs are widely used for tasks such as generative modeling, dimensionality reduction, and anomaly detection. They employ separate networks for encoding and decoding and utilize a probabilistic latent space to enable data reconstruction and generation. This probabilistic framework allows VAEs to balance reconstruction accuracy and the regularization of latent space, making them a versatile tool for various applications in machine learning [37]-[41].

Although current autoencoder technology works well, traditional autoencoders, including unidirectional VAEs, rely on separate networks for encoding and decoding, doubling the parameter count and computational burden.

Accordingly, there is a need for improving efficiency, scalability, and performance in data modeling tasks performed by autoencoders.

### SUMMARY OF THE INVENTION

In a variation, the bidirectional autoencoder is a bidirectional variational autoencoder. Characteristically, the bidirectional variational autoencoder uses a single parametrized network for encoding and decoding.

A method of training a bidirectional autoencoder is provided. The bidirectional autoencoder including a single bidirectional network for encoding and decoding wherein the encoding and decoding use the same synaptic weights. The single bidirectional network is configured to run as an encoder in a forward direction and as a decoder in a backward direction. The method includes steps of performing a forward pass through a bidirectional network to encode input data into a latent representation using a first set of synaptic weights and performing a backward pass through the bidirectional network to decode the latent representation into reconstructed data using a transpose of the first set of synaptic weights. The method also includes a step of optimizing a training error function with an optimization process that incorporates forward likelihood and backward likelihood to enhance data reconstruction accuracy.

In another aspect, a method for training a bidirectional variational autoencoder is provided. The bidirectional variational autoencoder includes a single bidirectional network for encoding and decoding wherein the encoding and decoding use the same synaptic weights. The single bidirectional network is configured to run as an encoder in a forward direction and as a decoder in a backward direction. The method includes steps of receiving a dataset of input samples and defining a latent space dimension and initializing synaptic weights for encoding and decoding, a learning rate, and other hyperparameters. The method further includes a step of iteratively performing steps 1)-4) comprising:
1) selecting a subset of samples from the dataset as a mini-batch;
2) predicting a variational mean from the input sample using a neural network and a log-variance from the input sample using the neural network;
3) sampling a latent variable by adding noise to the calculated mean scaled by the square root of the variance;
4) decoding the sampled latent variable to reconstruct an original input sample by reversing operation of the neural network.
   The method also includes a step of estimating a training loss by:
a. Calculating a Kullback-Leibler divergence term to measure a difference between a variational distribution and a standard Gaussian distribution;
b. Calculating a reconstruction loss to measure a difference between a reconstructed input and the original input sample; and
c. Combining a divergence term and reconstruction loss into a total training loss.
   The method also includes a step updating the synaptic weights by backpropagating gradients of the total training loss through the neural network. After the main loop has completed, the recalculated synaptic weights θ are returned.

In another aspect, the training loss for the bidirectional variational autoencoder is minimized using a gradient-based optimization algorithm.

### BRIEF DESCRIPTION OF THE DRAWINGS

For a further understanding of the nature, objects, and advantages of the present disclosure, reference should be made to the following detailed description, read in conjunction with the following drawings, wherein like reference numerals denote like elements and wherein:

FIG. 1a. Schematic of a bidirectional autoencoding network.

FIG. 1b. Schematic of a bidirectional variational autoencoding network.

FIG. 1c. Schematic of a computing system that can run the autoencoders.

FIG. 2. Image denoising with a bidirectional autoencoding network: The architecture of the new bidirectional autoencoder consists of a single bidirectional network N_{θ} for encoding and decoding. The encoding and decoding use the same synaptic weights. This bidirectional network runs as an encoder in the forward direction and as a decoder in the backward direction.

FIG. 3. Image denoising with a unidirectional autoencoding network: A unidirectional autoencoding network consists of two separate sub-networks with respective parameters θ and ϕ. They are the encoder network N_{θ} and the decoder network N_{ϕ}. The encoder maps the input space X to the latent space Z. The decoder network maps Z to Y. Bidirectional autoencoding networks use just one network.

FIGS. 4a, 4b, and 4c. Beta probability density function Beta(α, β): A discretized form of Beta(α=1+γₖ, β=2−γₖ) models the output layer of an autoencoder. The discretized beta describes the probability of the output-image pixel value y given the input image x. (a) The beta densities for γₖ=0.0 and γₖ=0.5. (b) Discretized beta density for the pixel value Xₖ=0 for pixel values γₖ∈{0, 1, . . . , 255}. The function is nonzero but the figure shows only the values γₖ∈{0, 1, . . . , 80}. (c) Discretized beta probability function for the pixel value Xₖ=128 for pixel values γₖ∈{0, 1, . . . , 255}. The figure shows only the values γₖ∈{88, 89, . . . , 168}.

FIGS. 5a, 5b, and 5c. Image compression and image denoising with fully connected autoencoders on the MNIST handwritten digit dataset: BAEs always outperformed the corresponding unidirectional AEs on these tasks. The AEs each used a latent variable of dimension 256. The plots show the peak signal-to-noise ratio (PSNR) after training. The AEs each trained over 200 epochs. (a) Data compression and reconstruction. (b) Denoising additive Gaussian noise. (c) Denoising multiplicative Gaussian (speckle) noise.

FIGS. 6a and 6b. t-distributed Stochastic Neighbor Embedding (t-SNE) features with autoencoder compression on MNIST handwritten digits: The compressed features from BAEs separate more easily than do those from unidirectional AEs. The figure shows the 2D projection of the latent-space representation of the compressed features with autoencoder networks. The dimension of the latent space was 144. The transformed features from the BAE separated better than did those for the unidirectional AE. (a) Unidirectional autoencoder features. (b) Bidirectional autoencoder features.

FIG. 7. TABLE 1.1: Image compression and reconstruction of the MNIST handwritten digit dataset with fully connected autoencoders: Bidirectional AEs always reduced the number of parameters by about 50% and outperformed the corresponding unidirectional AEs. The AEs trained over 200 epochs.

FIG. 8. TABLE 1.2: Image denoising on the MNIST handwritten digit dataset with fully connected autoencoders: BAEs always outperformed their corresponding unidirectional AEs. The AEs trained on additive noise and separately on multiplicative (speckle) noise. The AEs used a latent variable of dimension 256 and trained over 200 epochs. The unidirectional AEs each used 5.3 M trainable parameters while the BAEs each used 2.7 M trainable parameters.

FIG. 9. TABLE 1.3: Image compression and reconstruction with convolutional autoencoders on the CIFAR-10 image dataset: Bidirectional AEs with convolutional layers always significantly reduced the number of trainable synaptic parameters by about 50% and slightly outperformed their corresponding unidirectional AEs. These AEs trained over 300 epochs.

FIG. 10. TABLE 1.4: Image denoising with convolutional autoencoders on the CIFAR-10 image dataset: Bidirectional AEs always slightly outperformed their corresponding unidirectional AEs. The AEs were test on additive noise and on multiplicative (speckle) noise. The AEs used a latent variable of dimension 324. These AEs trained over 300 epochs. The unidirectional AEs each used 8 M trainable parameters and the bidirectional AEs each used 4 M trainable parameters.

FIG. 11. Algorithm 1.1 Training a bidirectional autoencoder with a form of bidirectional backpropagation for image denoising.

FIGS. 12a and 12b. Bidirectional vs. unidirectional variational autoencoders: Unidirectional VAEs use the forward passes of two separate networks for encoding and decoding. Bidirectional VAEs run their encoding on the forward pass and decoding on the backward pass with the same synaptic webs-weight matrices in both directions. This cuts the number of tunable parameters roughly in half. (a) The decoder network with parameter θ approximates p(x|z, θ) and the encoder network with parameter ϕ approximates q(z|x, θ). (b) Bidirectional VAEs use the forward pass of a network with parameter θ to approximate q(z|x, θ) and the backward pass of the network to approximate p(x|z, θ).

FIG. 13. Training a bidirectional variational autoencoder with bidirectional backpropagation algorithm: This framework uses a single network for encoding and decoding. The forward pass with likelihood q_{f}(z|x, θ) runs the encoding to the latent space. The backward pass with likelihood p_{b}(x|z, θ) decodes the latent features.

FIGS. 14a, 14b, and 14c. Bidirectional VAE with residual network architecture: This cuts the tunable parameters roughly in half compared with unidirectional VAEs. (a) is the bidirectional convolutional layer. Convolution runs in the forward pass and convolution transpose runs in reverse with the same set of convolution masks. (b) is the architecture of a bidirectional residual block with bidirectional skip connections. (c) Bidirectional residual VAE network.

FIGS. 15a and 15b. t-SNE embedding for the MNIST handwritten digit dataset: Latent space dimension is 128. (a) A simple linear classifier that trained on the unidirectional VAE-compressed features achieved a 95.2% accuracy. (b) The simple classifier achieved 97.32% accuracy when it trained on the BVAE-compressed features.

FIGS. 16a, 16b, 16c, and 16d. MNIST handwritten image: Image interpolation with variational autoencoder networks.

FIGS. 17a, 17b, 17c, and 17d. Image interpolation with VAEs on the Fashion-MNIST dataset.

FIG. 18. TABLE 2.1: MNIST handwritten digits dataset with VAEs. The residual network architecture was used. The dimension of the latent variable is 64. The BVAEs each used 42.2 MB storage memory and the VAEs each used 84.4 MB storage memory.

FIG. 19. TABLE 2.2: Fashion-MNIST dataset with VAEs. The residual network architecture was used. The dimension of the latent variable is 64. The BVAEs used 42.2 MB memory parameters and the unidirectional VAEs used 84 MB memory parameters.

FIG. 20. TABLE 2.3: CIFAR-10 dataset with VAEs. The dimension of the latent space is 256. The BVAEs each used 107 MB memory parameters and the unidirectional VAEs each used 214 MB memory parameters.

FIG. 21. TABLE 2.4: CelebA-64 dataset with VAEs. The dimension of the latent variable is 256. The BVAEs each used 133.8 MB memory parameters and the unidirectional VAEs each used 267.6 MB memory parameters.

FIG. 22. Algorithm 1 Training BVAEs with bidirectional backpropagation.

### DETAILED DESCRIPTION

Reference will now be made in detail to presently preferred embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

It should also be appreciated that integer ranges explicitly include all intervening integers. For example, the integer range 1-10 explicitly includes 1, 2, 3, 4, 5, θ, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

When referring to a numerical quantity, in a refinement, the term “less than” includes a lower non-included limit that is 5 percent of the number indicated after “less than.” A lower non-includes limit means that the numerical quantity being described is greater than the value indicated as a lower non-included limited. For example, “less than 20” includes a lower non-included limit of 1 in a refinement. Therefore, this refinement of “less than 20” includes a range between 1 and 20. In another refinement, the term “less than” includes a lower non-included limit that is, in increasing order of preference, 20 percent, 10 percent, 5 percent, 1 percent, or 0 percent of the number indicated after “less than.”

The term “one or more” means “at least one” and the term “at least one” means “one or more.” The terms “one or more” and “at least one” include “plurality” as a subset.

The term “substantially,” “generally,” or “about” may be used herein to describe disclosed or claimed embodiments. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software, and firmware components.

Throughout this application, where publications are referenced, the disclosures of these publications in their entireties are hereby incorporated by reference into this application to more fully describe the state of the art to which this invention pertains.

### ABBREVIATIONS

“AU” is the number of active latent units.
“CIFAR-10” is the dataset of 60,000 color images across 10 categories for image recognition tasks.
“CNN” is the convolutional neural network.
“ELBO” is the evidence lower bound.
“FCNN” is the fully connected neural network.
“KL-Divergence” is the Kullback-Leibler divergence.
“MNIST” is the dataset of handwritten digits used for machine learning tasks.
“PSNR” is the peak signal-to-noise ratio.
“SSIM” is the structural similarity index measure.
“t-SNE” is the t-distributed stochastic neighbor embedding.

The term “likelihood” refers to a function that measures how plausible a set of parameters θ is for a given statistical model, based on observed data x. Formally, if p(x|θ) represents the probability density or mass function of the observed data conditioned on the parameters, then the likelihood L(θ|x) is defined as L(θ|x)=p(x|θ). Unlike a probability distribution, the likelihood is not normalized with respect to θ and does not sum (or integrate) to 1. The likelihood function is central to many statistical and machine learning methods, such as Maximum Likelihood Estimation (MLE), where the goal is to find the parameter values θ that maximize L(θ|x), making the observed data most plausible under the model.

The term “joint likelihood” extends the concept of likelihood to account for multiple observations or events, providing a measure of how plausible the entire dataset is, given a statistical model. For a dataset consisting of n independent and identically distributed (i.i.d.) observations X={x₁, x₂, . . . , xₙ}, the joint likelihood is the product of the likelihoods of each observation: L(θ|X)=πᵢ₌₁²p(xᵢ|θ). If the observations are not independent, the joint likelihood incorporates their dependencies and is expressed as L(θ|X)=p(x₁, x₂, . . . , xₙ|θ). The joint likelihood plays a critical role in Bayesian inference and machine learning, as it combines information from all data points to quantify how well the model parameters θ explain the observed dataset.

The term “latent representation” refers to a compact, often lower-dimensional, encoding of input data that captures its most relevant features or characteristics. In the context of machine learning and neural networks, latent representations are typically the outputs of an intermediate layer in the network, such as the bottleneck layer of an autoencoder. In the context of a bidirectional autoencoder, a latent representation is the intermediate output generated during the forward pass, where the input data is transformed into a condensed form. This representation is stored in the latent space and serves as a bridge between the encoding and decoding processes.

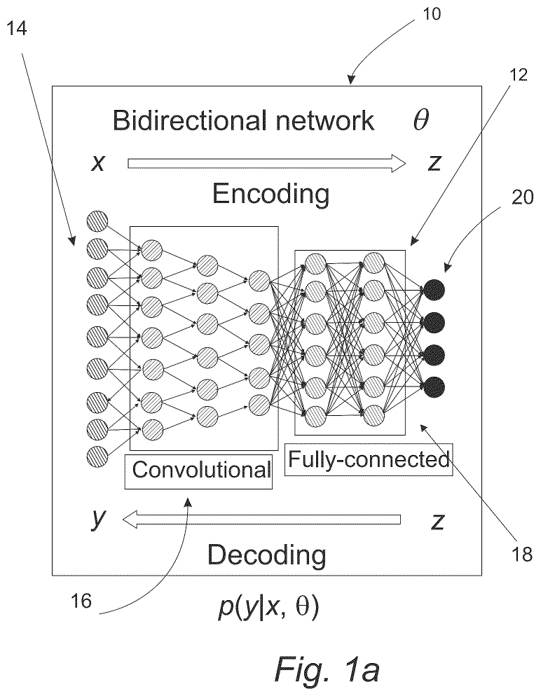

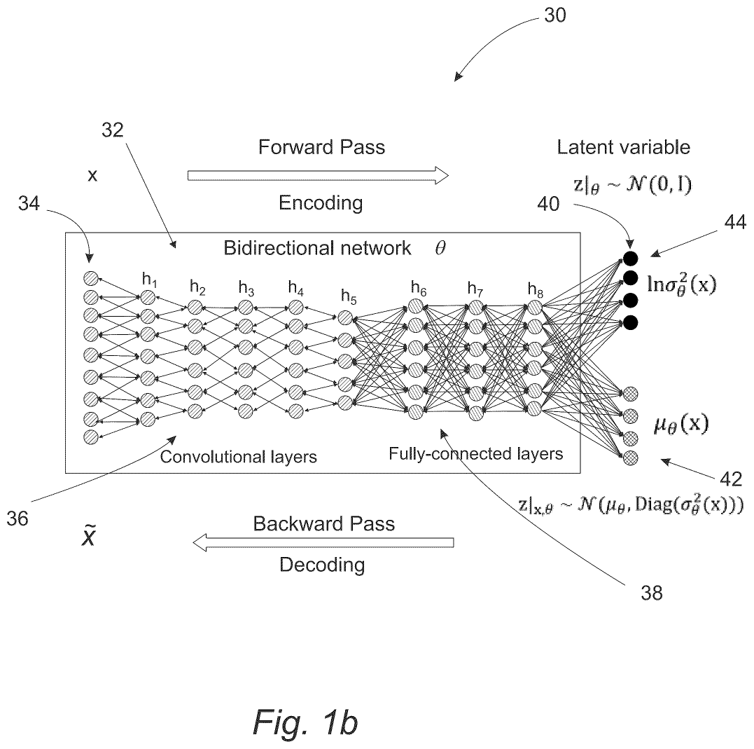

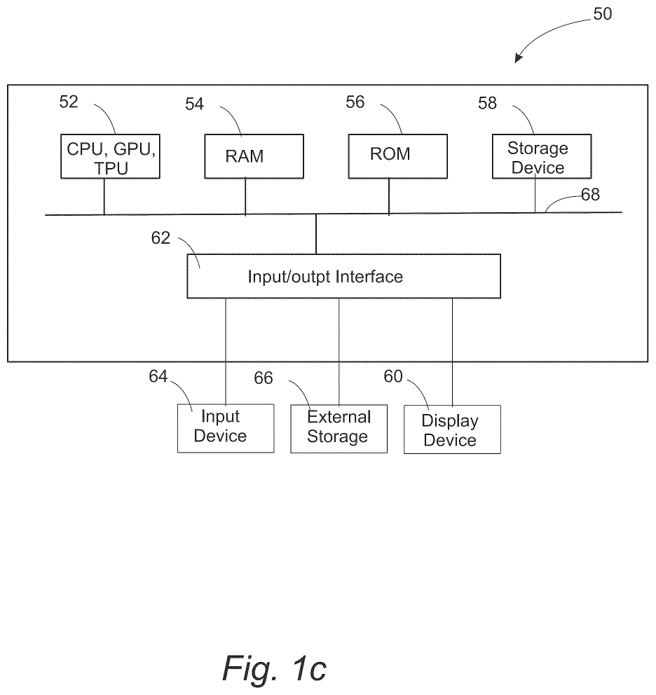

In an embodiment, a bidirectional autoencoder is provided. Referring to FIG. 1a, the bidirectional autoencoder 10 includes a single bidirectional network (N_{θ}) 12, and in particular, a single bidirectional neural network for encoding and decoding wherein the encoding and decoding use the same synaptic weights. The single bidirectional network (N_{θ}) 12 runs as an encoder in the forward direction and as a decoder in the backward direction. In a refinement, the single bidirectional network 12 is a neural network with input layer 14. Input layer 14 receives the input data, typically an image, vector, or other structured data and prepares the data for further processing by the following neural networks. In a further refinement, the single bidirectional network includes a convolutional neural network 16. In still a further refinement, the single bidirectional network can further include a fully connected neural network 18 that receives input from convolutional neural network 16. In this refinement, output layer 20 receives input from the fully connected neural network 18 and outputs the latent representation z.

In the bidirectional autoencoder, convolutional neural network 16, fully connected neural network 18, and output layer 20 work together within a single bidirectional network that performs both encoding and decoding using the same synaptic weights. Convolutional neural network 16 plays a critical role in feature extraction, particularly for high-dimensional and structured input data such as images. Through convolutional operations, convolutional neural network 16 detects localized spatial features like edges, textures, and patterns, progressively abstracting them across multiple layers. This process not only captures meaningful details but also reduces the input's spatial dimensions, retaining essential information while improving computational efficiency. Following convolutional neural network 16, fully connected neural network 18 integrates and transforms the extracted feature maps into a holistic representation. Each neuron in fully connected neural network 18 connects to all outputs of the previous layer, allowing for global interactions among the features. Fully connected neural network 18 maps the high-dimensional output of convolutional neural network 16 into a compact latent representation (z) in the latent space. This latent representation captures the most relevant characteristics of the input data, serving as the interface between the encoding and decoding phases. The output layer 20 of fully connected neural network 18 finalizes this process during the forward pass, outputting the latent representation (z), which is used for reconstruction or downstream tasks such as generation and classification. Together, convolutional neural network 16, fully connected neural network 18, and output layer 20 form an efficient and streamlined processing pipeline for the bidirectional autoencoder. During the forward pass (encoding), the input is processed through convolutional neural network 16, fully connected neural network 18, and output layer 20 to produce the latent representation (z). In the backward pass (decoding), the process is reversed, with the latent representation passed back through the output layer 20, fully connected neural network 18, and convolutional neural network 16 to reconstruct the input data. Convolutional neural network 16 specializes in capturing localized patterns, while the fully connected neural network 18 and output layer 20 work together to integrate these features into a cohesive and compact representation. This complementary relationship ensures that the bidirectional autoencoder efficiently encodes and decodes high-dimensional data while maintaining performance and reducing computational overhead.

In another aspect, the bidirectional autoencoder operates such that during the forward pass (or forward inference), the input data is processed through a rectangular weight matrix W, transforming the input into a latent representation. During the backward pass (or backward inference), the process is reversed to reconstruct the original input from the latent representation. This reconstruction is achieved by passing the latent representation through the transpose of the same weight matrix, W^{T}. By using the same weight matrix for both encoding (forward pass) and decoding (backward pass), the model simplifies its structure, reduces the number of trainable parameters, and ensures consistent transformations between the input and latent spaces.

In another aspect, the bidirectional autoencoder learns or approximates an identity mapping from an input pattern space to the same or similar output pattern space. In a refinement, the bidirectional autoencoder of is trained with a bidirectional backpropagation algorithm. In a further refinement, training maximizes a backward likelihood p(x|y, θ) of the bidirectional networks. In still a further refinement, an error function ε_{M}(x, θ) is minimized during training. Characteristically, the training error function ε_{M} (x, θ) equals the negative log-likelihood of M training samples with the assumption of independent and identical distribution.

In another aspect, a method of training a bidirectional autoencoder (BAE) is provided. The method includes performing a forward pass on input data to encode it into a latent representation using a first set of synaptic weight and performing a backward pass through the bidirectional network to decode the latent representation into reconstructed data using a transpose of the first set of synaptic weights. The method further includes a step of optimizing a training error function with an optimization process that incorporates forward likelihood and backward likelihood to enhance (e.g., increase) data reconstruction accuracy.

In a refinement, the optimization includes calculating a loss function backward error based on the difference between the reconstructed data and the input data and updating the synaptic weights using a gradient descent algorithm to minimize the loss function. In a refinement, the method includes a loss function that is a negative log-likelihood function of the reconstructed data which can be expressed as a cross-entropy between the input data and the reconstructed data. Advantageously, the forward and backward passes in the method are performed using shared synaptic weights within a single network, eliminating the need for separate encoder and decoder networks. In a further refinement, the method further comprises dynamically adjusting training parameters during training, including at least one of batch size, learning rate, number of epochs, or number of iterations per epoch. The forward pass in the method can transform the input data into a latent representation through a neural network, and the backward pass reconstructs the input data using the transposed synaptic weights. In still a further refinement, the method further comprises applying the trained bidirectional autoencoder to tasks including image compression, image denoising, or feature extraction. The training process in the method can be validated using performance metrics, including Peak Signal-to-Noise Ratio (PSNR) and Structural Similarity Index Measure (SSIM).

In another aspect, an algorithm trains the bidirectional autoencoder to minimize the backward error E_{b}(θ), ensuring the reconstructed outputs (a^{x}) match the target outputs (y). The forward pass compresses the input into a latent representation, while the backward pass reconstructs the input. The gradient descent step iteratively adjusts the network parameters θ, enabling the autoencoder to learn an efficient representation of the data and perform tasks like image denoising. The input requirements include a dataset (D) of training samples where D={(x⁽ⁱ⁾, y⁽ⁱ⁾}ᵢ₌₁^{N}^{ₜᵣ},x⁽ⁱ⁾ is input data (e.g., noisy images), y⁽ⁱ⁾ is target data (e.g., clean images), and Nₜᵣ is the total number of training samples. Hyperparameters are as follows: L is the batch size, the number of samples selected per iteration, ηθ is learning rate which controls the size of the steps in weight updates, and M is the total number of epochs (i.e., the number of complete passes through the dataset). B is the number of iterations per epoch, determined by how the data is divided into batches. Model Parameters (θ^{(θ)}) are θ which are the network parameters, including the weights and biases of the bidirectional autoencoder. They are initialized before training. After the network parameters θ are initialized to θ^{(θ)}, the algorithm executes a loop that includes the following steps. In step 1), iteration over epochs is performed by looping over m=0 to M, where m is an integer represent the current epoch and M is the total number of epochs. In step 2), a batch is selected by randomly selecting L samples from the dataset, denoted as {(x^{(l)}, y^{(l)})}ₗ₌₁^{L}. In step 3, the latent representation a^{z} for each sample l (where l is an integer label) is computed by passing the input x^{(l)} through the encoder network N_{θ}:

a^{z(l)}=N_{θ}(x^{(l)})

where N_{θ} is the encoding function, parameterized by θ, which maps input x^{(l)} to a lower-dimensional latent space, and a^{z(l)} is the latent (encoded) representation of input x^{(l)}. In step 4 (Backward Pass (Decoding)), the latent variable a^{z(l)} is decoded to reconstruct the input signal using the decoder N_{θ}^{T} (the transpose of the encoder):

a^{x(l)}=N_{θ}^{T}(a^{z(l)})

Ne is the decoding function, parameterized by θ, reconstructs the input signal from the latent representation and a^{x(l)} is the reconstructed version of the input signal. In step 5 (Compute Backward Error (E_{b}(θ))), the backward error is computed using the binary cross-entropy loss function:

$${E}_{b} ( θ ) = - \frac{1}{L} {\sum }_{l = 1}^{L} {\sum }_{k = 1}^{K} ( {y}_{k}^{( l )} ln {a}_{k}^{{x}_{b}^{( l )}} + ( 1 - {y}_{k}^{( l )} ) ln ( 1 - {a}_{k}^{{x}_{b}^{( l )}} ) )$$

where yₖ^{(l)} is the ground truth (target) value for the k-th output of the l-th sample. yₖ^{(l)} is a binary value where yₖ^{(l)}=1 if the k-th class is the correct target and otherwise,

$${y}_{k}^{( l )} = 0 \cdot {a}_{k}^{{x}_{b}^{( l )}}$$

is the predicted activation (output probability) for the k-th output of the l-th sample, computed during the backward pass. L is the number of samples in the current batch and K is the number of output nodes (or classes). The first term

$${y}_{k}^{( l )} ln {a}_{k}^{{x}_{b}^{( l )}} ,$$

measures the loss for correctly predicting the target class. The second term,

$$( 1 - {y}_{k}^{( l )} ) ln ( 1 - {a}_{k}^{{x}_{b}^{( l )}} ) ,$$

penalizes the model for assigning probabilities to incorrect classes. In step 6 (Update the Weights), the model parameters θ are updated using gradient descent: θ^{(m+1)}=θ^{(m)}−η1∇_{θ}E_{b}(θ)|_{θ=θ}^{(m)}. where ηθ is the learning rate, which controls the magnitude of the parameter update; and ∇_{θ}E_{b}(θ) is the gradient of the backward error E_{b}(θ) with respect to the parameters θ. In step 7, continue the loop over batches and epochs until the total number of epochs M is completed.

In another aspect, the bidirectional autoencoder 10 described herein has a range of applications across various domains due to its ability to encode input data into compact latent representations and reconstruct data with high fidelity. One key application is image compression, where the BAE reduces the dimensionality of high-resolution images by encoding them into a latent space, significantly lowering storage and transmission requirements. The reconstructed images from the compressed features retain essential details, making this approach highly effective for efficient storage in resource-constrained systems and reducing bandwidth usage in image transmission. In a refinement, a method for compressing images using bidirectional autoencoder 10 involves processing the input data through a series of coordinated steps. First, an input image is received through an input layer of the bidirectional network. During the forward pass, spatial features are extracted from the input image using a convolutional neural network 16. These features are then transformed into a latent representation by a fully connected neural network 18, which serves as a compact and efficient encoding of the input image. During the backward pass, the input image is reconstructed from the latent representation using transposed operations of the convolutional neural network 16 and fully connected neural network 18. The latent representation, which encapsulates the essential information of the input image in a reduced-dimensional form, is then stored or transmitted as the compressed representation of the image. This method ensures efficient compression while maintaining the ability to reconstruct the original image with high fidelity.

In another aspect, another important application is image denoising, where bidirectional autoencoder 1θ is trained to reconstruct clean images from noisy inputs. By learning to separate noise from underlying features in the data, bidirectional autoencoder 10 enhances image quality, making it valuable for applications such as medical imaging (e.g., improving the clarity of MRI or CT scans), surveillance (e.g., refining low-light or grainy video feeds), and professional photography (e.g., removing unwanted visual artifacts). In a refinement, a method for denoising images using a bidirectional autoencoder 10 includes the following steps. First, a noisy input image is received through an input layer of the bidirectional network. During the forward pass, spatial features are extracted from the noisy image using a convolutional neural network 16, which captures essential patterns while reducing noise. These extracted features are then transformed into a latent representation by a fully connected neural network 18, providing a compact encoding of the input data. In the backward pass, a denoised image is reconstructed from the latent representation using transposed operations of the convolutional neural network 16 and fully connected neural network 18. To enhance the network's performance, the parameters are optimized by minimizing a reconstruction loss, which quantifies the difference between the reconstructed denoised image and a reference image, ensuring high-quality denoising results.

In another aspect, bidirectional autoencoder 10 also excels in feature extraction, where it learns a compact latent representation of the input data that preserves the most relevant features. These latent features can be used in downstream tasks such as clustering, classification, and anomaly detection. For example, in image recognition tasks, the latent features extracted by the BAE can serve as inputs to classifiers, reducing computational complexity and improving model performance.

In addition, bidirectional autoencoder 1θ is a powerful tool for data visualization. By combining the encoded features with dimensionality reduction techniques like t-SNE, it enables the visualization of high-dimensional datasets in a lower-dimensional space, facilitating pattern recognition and exploratory data analysis. For instance, in research and diagnostics, t-SNE visualizations of the BAE's encoded features can reveal relationships or clusters that are otherwise hidden in raw high-dimensional data.

The BAE is also highly effective for representation learning, where the encoded latent space provides a meaningful representation of the input data. These learned representations can be reused in transfer learning scenarios or as pre-trained features for other machine learning models, improving their performance, and reducing training times. For example, in complex tasks like object detection, the BAE's learned features can serve as a robust foundation for downstream models.

Another significant application is anomaly detection, where bidirectional autoencoder 10 identifies discrepancies between reconstructed and input data. This capability is especially valuable in fields such as fraud detection, where unusual patterns in financial transactions can be flagged, or in industrial settings, where equipment malfunctions can be detected early by identifying deviations from normal operation patterns.

Finally, bidirectional autoencoder 10 can be applied to domain-specific tasks such as handwriting recognition using datasets like MNIST and object recognition using datasets like CIFAR-10. In these scenarios, bidirectional autoencoder 10 leverages its ability to encode and reconstruct data to process and analyze structured datasets, improving classification accuracy and enabling enhanced image analysis. These applications demonstrate bidirectional autoencoder 10's versatility in solving real-world problems that require data reconstruction, noise reduction, and dimensionality reduction.

In another aspect, an application-specific integrated circuit (ASIC) for bidirectional autoencoding is provided. The ASIC includes an input interface configured to receive input data (e.g., noisy image data). The ASIC further includes a bidirectional autoencoding processing unit, a memory module, an optional control unit, and an output interface. The bidirectional autoencoding processing unit includes a forward processing module that encodes the input image data into a latent representation using a single set of synaptic weight matrices and a backward processing module that decodes the latent representation into a reconstructed image by applying the transpose of the synaptic weight matrices. The memory module stores the synaptic weight matrices shared between the forward and backward processing modules and the latent representation generated during encoding. In a refinement, the control unit is configured to execute a bidirectional backpropagation training algorithm that optimizes the synaptic weight matrices by maximizing the backward likelihood of the reconstructed image with respect to the input data, using cross-entropy as the loss function and operating in an inference mode to perform tasks (e.g., real-time image compression and denoising) by processing data through the bidirectional autoencoding processing unit. The ASIC further includes an output interface configured to output the reconstructed data. In a refinement, a performance monitoring module computes peak signal-to-noise ratio (PSNR) and structural similarity index (SSIM) metrics to evaluate the quality of the reconstructed image.

In a variation, a system for encoding and decoding data using a bidirectional variational autoencoder is provided. Referring to FIG. 1b, the variational autoencoder system 30 includes a single bidirectional network 32, and in particular, a single bidirectional neural network configured to perform both encoding and decoding operations using shared synaptic weights, a forward pass mechanism to encode input data into a latent representation, and a backward pass mechanism to decode the latent representation back into reconstructed data. In a refinement, the single bidirectional network 32 is a neural network with input layer 34. Input layer 34 receives the input data, typically an image, vector, or other structured data and prepares the data for further processing by the following neural networks. In a further refinement, the single bidirectional network includes a convolutional neural network 36. In still a further refinement, the single bidirectional network can further include a fully connected neural network 38 that receives input from convolutional neural network 36. In this refinement, output layer 40 receives input from the fully connected neural network 38 and provides an output that splits into two branches. One branch 42 predicts the mean (μ):

$$μ = {W}_{θ} \cdot h + {b}_{μ}$$

where W_{θ}θ is the weight matrix used for predicting the mean, h is the feature vector, and b_{μ} is the bias vector for branch 42. The other branch 44 predicts the log-variance (In σ²).

$$ln {σ}^{2} = {V}_{θ} \cdot h + {b}_{ln {σ}^{2}}$$

where V_{θ}θ is the weight matrix used for predicting the log-variance, h is the feature vector, and b_{lnσ}² is the bias vector for branch 44. The output of these layers is used in the reparameterization step to sample from the latent distribution: z=μ+ϵ·σ where σ=\sqrt{exp(ln σ²)}.

In the variational autoencoder system 30, the convolutional neural network 36 and fully connected neural network 38 work in tandem to encode input data into a latent representation and facilitate its reconstruction. Convolutional neural network 36 is primarily tasked with extracting meaningful features from the input data, such as images, vectors, or other structured forms. By processing the input through multiple convolutional layers, convolutional neural network 36 detects spatial features like edges, patterns, and textures, which are essential for understanding the input's underlying structure. Additionally, convolutional neural network 36 reduces the spatial dimensions of the data through operations such as pooling, retaining critical information while improving computational efficiency. The extracted feature maps generated by convolutional neural network 36 are then passed to fully connected neural network 38 for further processing. Fully connected neural network 38 plays a complementary role by integrating the features from convolutional neural network 36 and mapping them into a more compact, structured latent space representation. Each neuron in fully connected neural network 38 is fully connected to the outputs of the preceding layer, enabling it to combine the extracted features into a cohesive representation. Fully connected neural network 38 generates two outputs: one branch predicts the mean (μ) and the other predicts the log-variance (lnσ²) of the latent distribution. These parameters are essential for the reparameterization step, where the latent variable (z) is sampled using the formula z=μ+ϵ·σ, with α=\sqrt{exp(lnσ²)}. This probabilistic encoding bridges the encoding and decoding phases of the variational autoencoder, allowing the model to sample from the latent distribution. Together, convolutional neural network 36 and fully connected neural network 38 form a cohesive pipeline where the CNN specializes in extracting localized features and reducing dimensionality, while the fully connected neural network 38 integrates these features into the latent representation and prepares them for the probabilistic framework of the VAE. This collaboration ensures efficient encoding and reconstruction of high-dimensional data, leveraging the strengths of both local feature extraction and global feature integration.

In another aspect, the bidirectional variational autoencoder system 30 includes a bidirectional backpropagation algorithm configured to optimize directional likelihoods for the forward and backward passes simultaneously and a memory module for storing the synaptic weights. The bidirectional structure reduces parameter count compared to traditional encoder-decoder architectures.

In another aspect, during training, the bidirectional variational autoencoder system 30 learns to approximate the posterior q(zx, θ) by predicting its parameters—the mean (μ) and log-variance lnσ². These parameters are updated iteratively as the network learns from the data, meaning the posterior distribution evolves to better represent the latent structure of the input data. The posterior is refined to encode data-specific features while regularizing against the prior p(z).

In another aspect, the bidirectional variational autoencoder is trained with a bidirectional backpropagation algorithm that jointly optimizes the single bidirectional network's joint bidirectional likelihood. In a refinement, the bidirectional variational autoencoder allows direct computation of ln p(x|θ) wherein p(x|θ) is the data likelihood. In a further refinement, the bidirectional variational autoencoder the same bidirectional associative network to model the encoding and decoding phases. As set forth below in more detail, a forward-pass likelihood p(x|z, θ) models the encoding and a backward-pass likelihood q(x|z, θ) models the decoding.

In another aspect, the invention provides a system wherein the bidirectional backpropagation algorithm uses an adaptive learning rate optimizer.

In another aspect, the invention provides a method for encoding and decoding data using a bidirectional variational autoencoder. The method involves receiving input data, encoding the input data into a latent representation using a forward pass through a neural network, and decoding the latent representation back into reconstructed data using a backward pass through the same neural network. The method further includes optimizing the encoding and decoding processes using a bidirectional backpropagation algorithm and regularizing the latent space using a predefined prior distribution over the latent variables. In a refinement, the prior distribution is a Gaussian distribution with mean zero and unit variance.

In another aspect, the method further includes visualizing the latent space representations using dimensionality reduction techniques, such as t-Distributed Stochastic Neighbor Embedding (t-SNE). This technique transforms high-dimensional latent representations into a two- or three-dimensional space, making it possible to visually assess the structure and separability of the latent features.

In another aspect, the invention provides a bidirectional variational autoencoder produced by the following method. The method includes configuring a neural network with shared weights for bidirectional operations, training the neural network with a bidirectional backpropagation algorithm to optimize forward and backward directional likelihoods, using a Gaussian prior distribution to regularize the latent space, and validating the autoencoder's performance on image reconstruction, classification, interpolation, and generation tasks.

In another aspect, a system for training a bidirectional variational autoencoder is provided. The system includes a training dataset comprising input samples, a neural network configured for bidirectional operations, and a bidirectional backpropagation algorithm to jointly optimize forward and backward directional likelihoods. The system further includes a module for calculating the evidence lower bound (ELBO) as a sum of forward and backward likelihoods and a processor configured to adjust synaptic weights of the neural network based on ELBO optimization.

In another aspect, the invention provides a method for training a bidirectional variational autoencoder. The method involves initializing synaptic weights of a neural network, using forward and backward passes to compute respective directional likelihoods for encoding and decoding operations, and calculating the evidence lower bound (ELBO) as a combination of forward and backward log-likelihoods. The method further includes updating the synaptic weights using gradient-based optimization techniques and iteratively refining the neural network to minimize reconstruction error and ensure adherence to a predefined prior distribution.

In another aspect, the invention provides a bidirectional backpropagation algorithm for training a neural network. The algorithm involves receiving a mini-batch of input data, performing a forward pass to encode input data into a latent representation, and performing a backward pass to decode the latent representation into reconstructed data. The algorithm further includes computing a loss function comprising a reconstruction loss and a KL-divergence term between the variational posterior and the prior distribution and updating synaptic weights of the neural network based on gradients of the loss function. An example of a useful algorithm for training is as follows. The input requirements include a dataset of data {xₙ})ₙ₌₁^{N} and latent space dimension J·{xₙ}ₙ₌₁^{N} is the dataset of N input samples, where each individual sample is xₙ. J is the dimension of the latent space, representing the size of the latent variable. Synaptic weights (e.g., θ∈{N_{θ}, V_{θ}, W_{θ}}), learning rate α, and other hyperparameters are initialized. θ is the set of synaptic weights, including N_{θ}, V_{θ}, and W_{θ} where N_{θ} is the weight matrix used for the first neural network layer, V_{θ} is the weight matrix used for predicting the log-variance, and W_{θ} is the weight matrix used for predicting the mean. After the parameters are initialized, the algorithm executes a loop that includes the following steps. Step 1 includes selecting a mini-batch {xₘ}ₘ₌₁^{B} of B samples for each iteration t where B is the size of the mini-batch selected during each training iteration. Step 2 includes executing a subloop for m iterations. Subloop step s1) (Forward Pass (Encoding)) includes predicting the variational mean and log-covariance:

μₘ=W_{θ}(N_{θ}(xₘ))

and

ln\hat{σ}ₘ²=V_{θ}(N_{θ}(xₘ))
μₘ represents the variational mean for the latent variable z, which is predicted by the encoder during the forward pass;
\hat{μ}ₘ is the predicted mean of the latent Gaussian distribution for the m-th sample in the mini-batch.
ln\hat{σ}ₘ² is the predicted logarithm of the variance for the latent Gaussian distribution for the m-th sample.
\hat{σ}ₘ² is the predicted variance for the latent Gaussian distribution for the m-th sample.

Subloop step s2 includes sampling the latent features zₘ from the variational Gaussian distribution conditioned on xₘ:

$${ϵ}_{m} \sim 𝒩 ( 0 , I ) , \qquad {z}_{m} = {μ}_{m} + {ϵ}_{m} \cdot {\hat{σ}}_{m}$$

where ϵₘ is a random noise vector sampled from a standard normal distribution; zₘ is the latent variable for the m-th sample, computed using the predicted mean, variance, and noise; [symbol] (0, 1) is the standard normal distribution with a mean of 0 and an identity covariance matrix I.

Subloop step s3 (Backward Pass (Decoding)) includes mapping the latent variable back to the input space:

âₘ^{(x)}=N_{θ}^{T}(W_{θ}^{T}(zₘ))

âₘ^{(x)} refers to the decoded output during the backward pass of the BVAE. The subloop terminated after B iterations.

Step 3 includes estimating the negative log-likelihood NLL(x, θ):

$$Kullback - Leibler Divergence ( KLD ) :$$

$$KLD ( x , θ ) = \frac{1}{B} {\sum }_{m = 1}^{B} {D}_{KL} ( 𝒩 ( {μ}_{m} , Diag ( {\hat{σ}}_{m}^{2} ) ) ‖ 𝒩 ( 0 , I ) )$$

$$Binary Cross - Entropy ( BDE ) :$$

$$BCE ( x , θ ) = - \frac{1}{B} {\sum }_{m = 1}^{B} ln {p}_{b} ( {x}_{m} \vert {z}_{m} , θ )$$

$$Evidence Lower Bound ( ELBO ) :$$

$${\hat{L}}_{ELBO} ( x , θ ) = BCE ( x , θ ) + KLD ( x , θ ) .$$

where \hat{L}_{ELBO}(x, θ)=−ELBO(x, θ, ϕ); and [symbol] (μₘ, Diag(\hat{σ}ₘ²)) is the Gaussian distribution defined by the predicted mean μₘ and diagonal covariance matrix derived from the variance &. During training, \hat{L}_{ELBO}(x, θ) (i.e., the negative of the ELBO) is minimized. Step 3 includes updating θ by backpropagating \tilde{L}_{ELBO}(x, θ) through the weights. The loop continues until a predetermined \hat{L}_{ELBO}(x, θ) is achieved or a predetermined number of iterations completed. The θ are then returned.

In another aspect, the invention provides an algorithm wherein the reconstruction loss is calculated using a combination of Peak Signal-to-Noise Ratio (PSNR) and Structural Similarity Index Measure (SSIM).

In another aspect, the methods for training the BVAE includes a step of monitoring performance metrics, including reconstruction accuracy and divergence minimization, to evaluate training effectiveness.

In another aspect, an ASIC for implementing a bidirectional variational autoencoder (BVAE) is provided. The ASCIC includes an input interface for receiving input data, a bidirectional variational processing unit, a memory module, a control unit, and an output interface. The bidirectional variational processing unit includes a forward processing module that encodes input data into a latent representation using a probabilistic forward likelihood q(z|x, θ) and a backward processing module that decodes the latent representation into reconstructed data using a probabilistic backward likelihood p_{b}(x|z, θ), with both processes sharing a single set of synaptic weights. The memory module stores the shared synaptic weights, latent representations, and network parameters. In a refinement, the control unit is configured to execute a bidirectional backpropagation algorithm during training, which jointly optimizes the forward and backward likelihoods to maximize the evidence lower bound (ELBO) on the data log-likelihood, incorporating steps such as computing the Kullback-Leibler (KL) divergence for regularization and minimizing reconstruction loss using cross-entropy. In a further refinement, the training process involves iterative updates of network weights based on gradient descent using a stochastic mini-batch approach. The control unit further enables inference tasks such as image reconstruction, classification, interpolation, and generation after training is complete. The ASIC also includes an output interface for providing reconstructed or generated data. In a refinement, a performance monitoring module evaluates the quality of the output data using metrics such as negative log-likelihood (NLL), peak signal-to-noise ratio (PSNR), structural similarity index measure (SSIM), and Frechet Inception Distance (FID).

In another aspect, the Bidirectional Variational Autoencoder (BVAE) reduces the number of parameters by about 50% while improving performance. This significant reduction in parameter size not only enhances the efficiency of chip hardware and software but also enables improved applications across various domains, including large language models, speech, image, and knowledge processing. These advancements position the BVAE as a pivotal tool for optimizing hardware and software requirements while simultaneously driving progress in generative AI models and other computational tasks.

FIG. 1c provides a schematic of a computing system that can encode the bidirectional autoencoder and implement the methods set forth above. In particular, the computing system implements the steps set forth above, which can be implemented by a computer program executing on a computing device. Computing system 50 includes a processing unit 52 that executes the computer-readable instructions for the computer-implemented steps. Computer processing unit 52 can include one or more central processing units (CPU), graphics processing units (GPU), or tensor processing units (TPU). Computer system 50 also includes RAM 54 or ROM 56 that can have computer implemented instructions encoded thereon. In some variations, computing device 50 is configured to display a user interface on display device 60.

Still referring to FIG. 1c, computer system 50 can also include a secondary storage device 18, such as a hard drive. Input/output interface 62 allows interaction of computing device 50 with an input device 64 such as a keyboard and mouse, external storage 66 (e.g., DVDs and CDROMs), and a display device 60 (e.g., a monitor). Processing unit 52, the RAM 54, the ROM 56, the secondary storage device 18, and the input/output interface 60 are in electrical communication with (e.g., connected to) bus 68. During operation, computer system 50 reads computer-executable instructions (e.g., one or more programs) for the bidirectional autoencoder methods recorded on a non-transitory computer-readable storage medium, which can be secondary storage device 58 and or external storage 66. Processing unit 52 executes these reads computer-executable instructions set forth above. Specific examples of non-transitory computer-readable storage medium for which executable instructions for the computer implements methods set forth above are encoded onto include, but are not limited to, a hard disk, RAM, ROM, an optical disk (e.g., compact disc, DVD), or Blu-ray Disc (BD)™), a flash memory device, a memory card, and the like. In other variations, a non-transitory computer memory has instruction encoded thereon for creating and/or training the bidirectional autoencoder set forth above.

Additional details of the invention are set forth below and in O. Adigun and B. Kosko, “Bidirectional Backpropagation Autoencoding Networks for Image Compression and Denoising,” 2023 International Conference on Machine Learning and Applications (ICMLA), Jacksonville, FL, USA, 2023, pp. 730-737, doi: 10.1109/ICMLA58977.2023.00107 and Kosko, Bart & Adigun, Olaoluwa. (2024). Bidirectional Variational Autoencoders. 10.1109/IJCNN60899.2024.10650379 and any supplemental materials for these papers; the entire disclosures of which are hereby incorporated by reference in their entirety.

The following examples illustrate the various embodiments of the present invention. Those skilled in the art will recognize many variations that are within the spirit of the present invention and scope of the claims.

### 1. Bidirectional Backpropagation Autoencoding Networks for Image Compression and Denoising

### 1.1. Bidirectional Autoencoders

A new bidirectional backpropagation algorithm is demonstrated as a method for training an autoencoder (AE) network. The resulting bidirectional AE uses a single network and the same synapses for forward and backward passes.

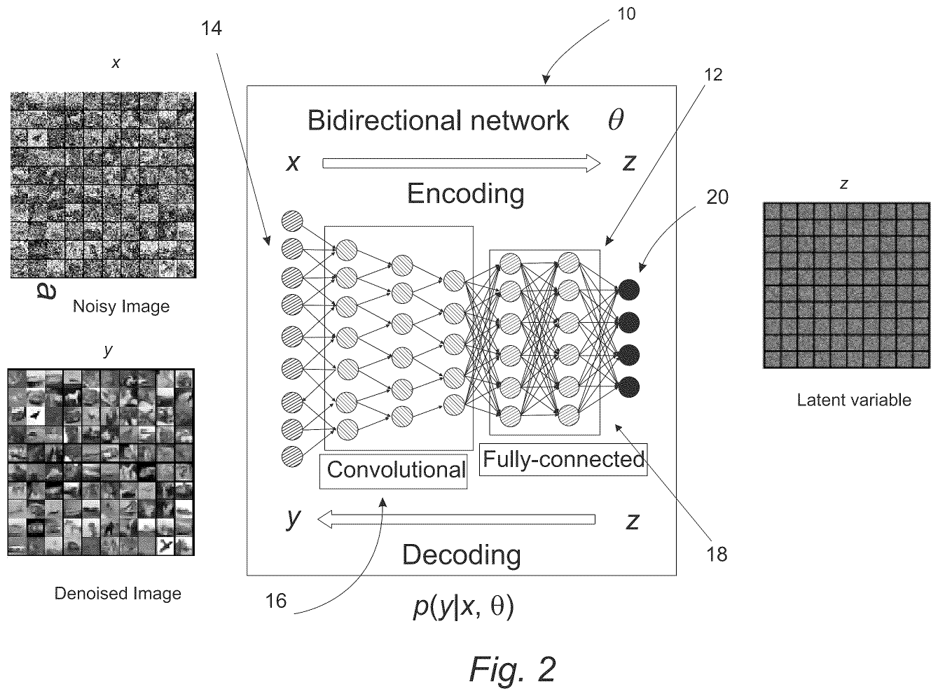

FIG. 2 shows the bidirectional architecture of a bidirectional AE (BAE). The BAE takes as input the noisy pattern x and passes it through the network Ne to produce the encoded vector z. The decoding step passes z back through the transposed synaptic weight matrices of No.

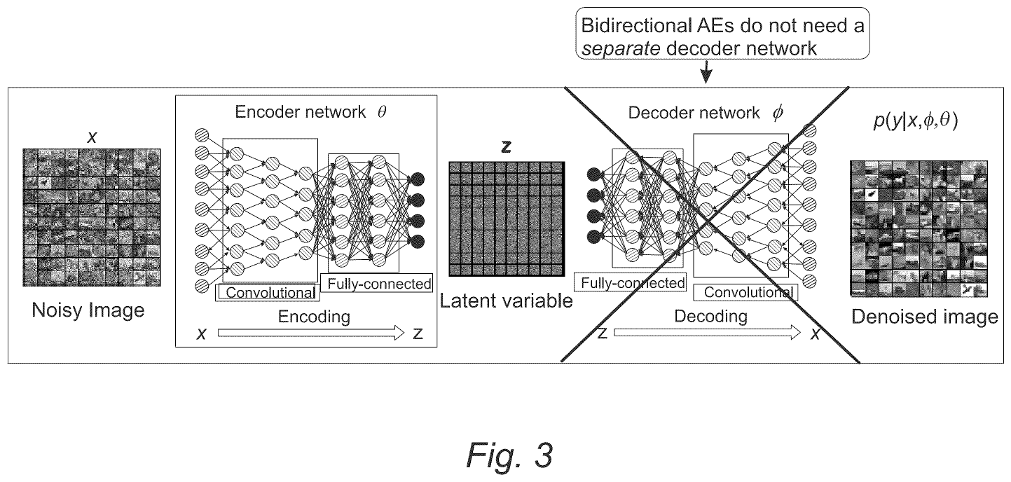

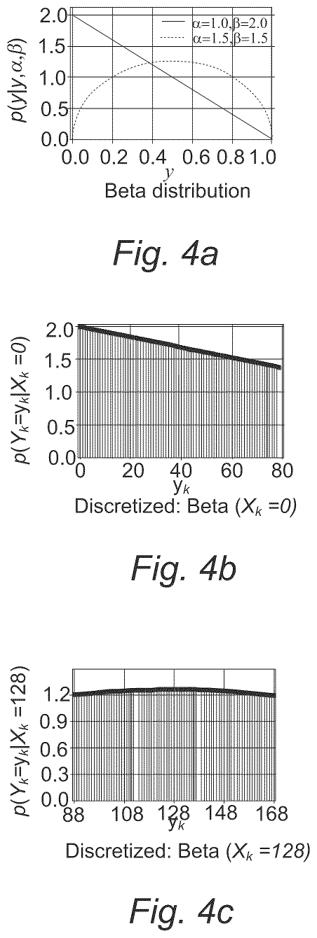

FIG. 3 compares the architecture of unidirectional AEs with the new BAEs. A unidirectional AE needs a separate network for decoding while a BAE uses the same network for encoding and decoding. FIG. 4 shows examples of the discretized beta probability densities that model the output layer of autoencoders. Algorithm 1.1 gives the pseudocode for training BAEs with a simple form of the new bidirectional backpropagation algorithm.

Bidirectional backpropagation [22], [23] maximizes a network's joint likelihood p_{f}(y|x, θ)p_{b}(x|y, θ). The forward probability p_{f}(y|x, θ) describes the forward pass of input pattern x from the input layer to the output layer. The backward probability p_{b}(x|y, θ) describes the backward pass of target y from the output layer to the input layer. BAE training differs from bidirectional backpropagation because it maximizes just the network's backward likelihood.

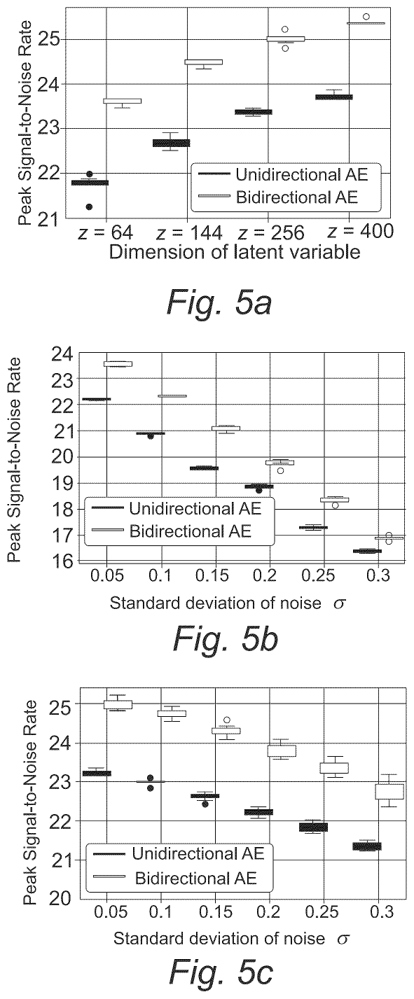

FIG. 5 shows that BAEs increase the peak signal-to-noise ratio (PSNR) on tasks of image compression and denoising using the MNIST handwritten digit dataset. Table 1.1 shows the BAE gain in PSNR. BAEs reduced the parameter count by about 50% on the image-compression task. Table 1.2 shows the BAE gain in PSNR on denoising images corrupted with additive noise and with multiplicative noise. Table 1.3 compares unidirectional AEs and BAEs on image compression with the CIFAR-10 image dataset. The table shows that BAEs increase the PSNR, they increase the structural similarity index measure (SSIM), and they reduce the parameter count. Table 1.4 shows a similar bidirectional benefit on denoising the CIFAR-10 image dataset.

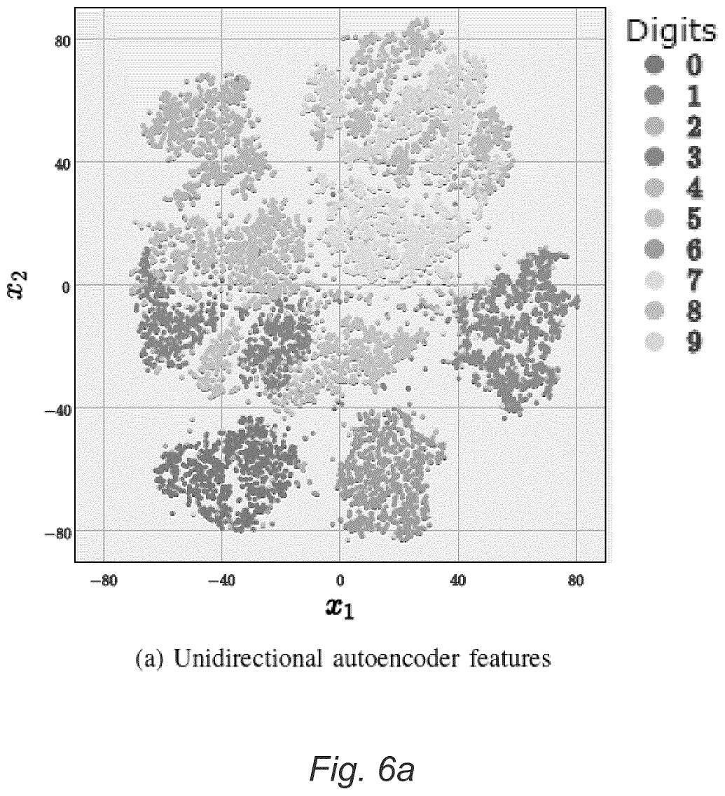

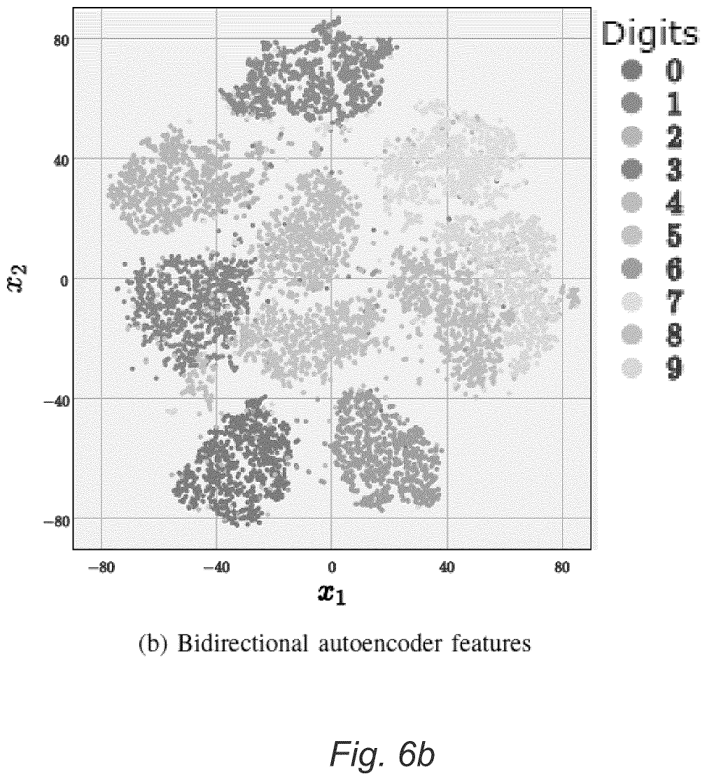

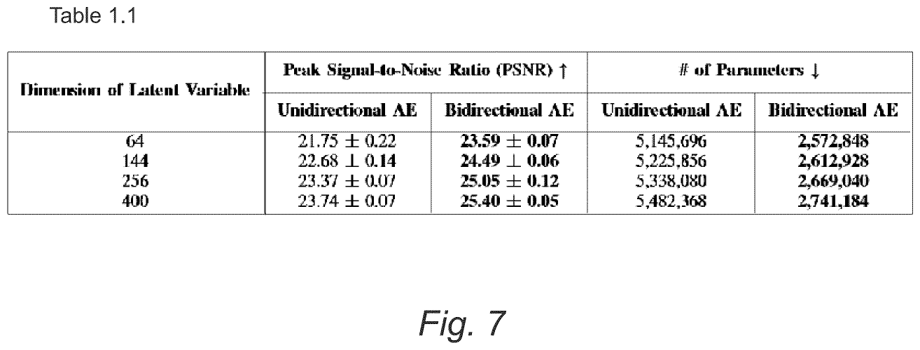

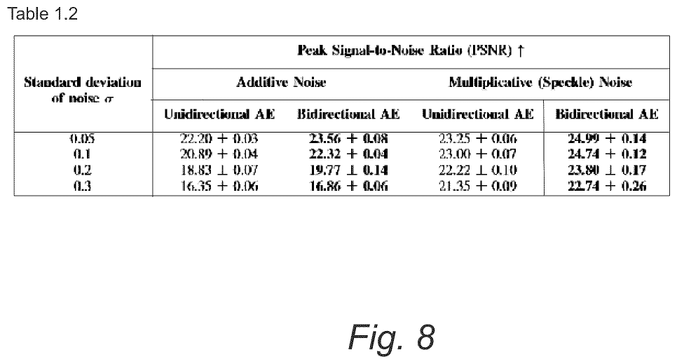

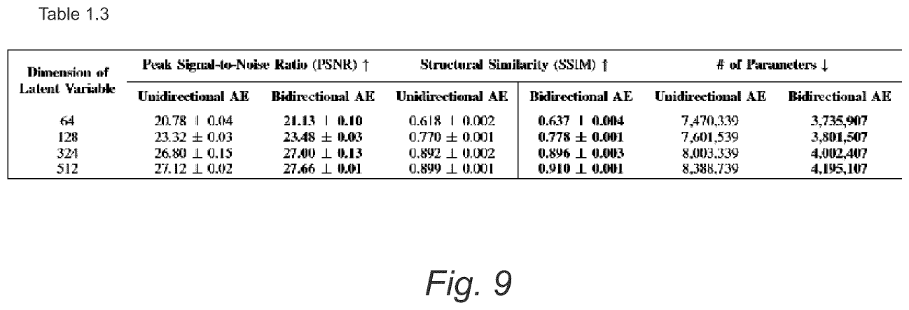

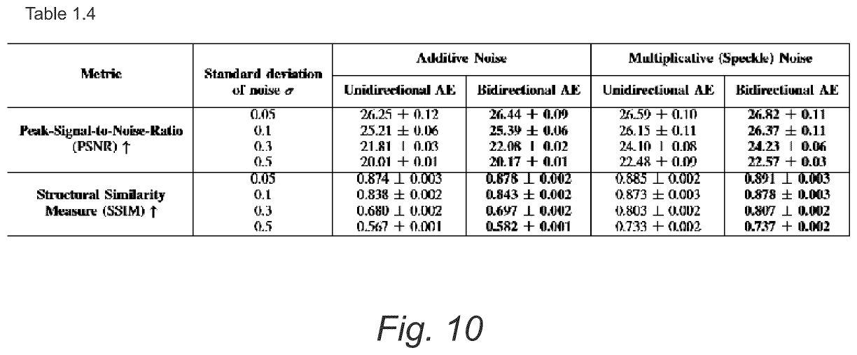

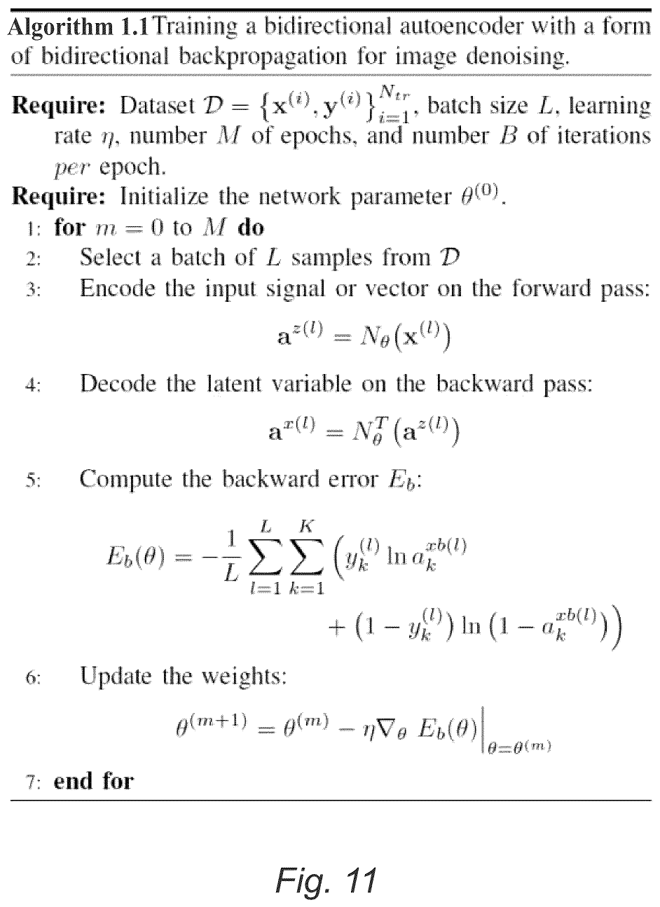

FIG. 6 compares the encoded or compressed features projected onto a 2D space. The projection used the t-distributed stochastic neighboring embedding (t-SNE) method [24]. The projected bidirectionally encoded features separated more easily into their respective categories.

Preliminary results also showed that the bidirectional backpropagation architecture extends to variational autoencoders. Here the forward error measures the Kullback-Leibler divergence between the encoded vector z and a target prior probability. The backward error measures the reconstruction error. The bidirectional framework offers a simple alternative to the reparameterization trick in variational AEs [25].

The next section presents the unidirectional AEs used in the simulations.

### 1.2. Unidirectional Autoencoders

An ordinary or unidirectional AE consists of two contiguous networks. These are the encoder network and the decoder network.

FIG. 3 shows the architecture of such an autoencoder. The terms θ and ϕ denote the respective weights of the encoder network N_{θ} and the decoder network N_{ϕ}. The encoder has output activation a^{z}=N_{θ}(x) where x is the input vector or signal. The decoder has output activation a^{y}=a^{y}=N_{ϕ}(x). It gives the reconstructed input or signal where a^{Z} is the encoded signal.

The output layer of neural networks for image-related tasks can be modeled as discretized independent beta random variables Y₁, . . . , Y_{K}. Ma and Leijon [26] have found that the beta probability density gives a reasonable model for such image pixel values. The random variables are Y_{K|X=x}˜Beta(α=1+γₖ, β=2−γₖ) where the beta density is discretized. This choice of the two beta parameters coincides with a continuous Bernoulli [27], [28]. This discretization models the finite cardinality of the set of all pixel values. Yₖ denotes the k^{th} neuron or pixel at the output layer of the decoder. It has the target pixel value

$${y}_{k} = \frac{c}{255}$$

for some c∈{0, 1, . . . , 255}.

The pixel values are not continuous and again the support of the beta structure assumes discretized values. This allows multi-level representation with 2 or more levels and assists image representation because it gives a multi-level model for the 256 possible values per pixel.

The decoder's output negative log-likelihood equals the double cross-entropy between the output activation a^{y} and the target y. This gives the output likelihood p(γₖ|x, θ, ϕ) as

$$p ( {y}_{k} \vert x , θ , ϕ ) = Beta ( {a}_{k}^{y} \vert α = 1 + {y}_{k} , β = 2 - {y}_{k} ) \qquad ( 1.1 )$$

$$= \frac{Γ ( 3 )}{Γ ( 1 + {y}_{k} ) Γ ( 2 - {y}_{k} )} {( {a}_{k}^{{y}_{k}} )}^{( {y}_{k} )} {( 1 - {a}_{k}^{{y}_{k}} )}^{( 1 - {y}_{k} )} . \qquad ( 1.2 )$$

The corresponding log-likelihood is

$$\begin{matrix}\begin{matrix}l ( {y}_{k} \vert x , θ , ϕ ) = ln p ( {y}_{k} \vert x , θ , ϕ ) & \\ = ln \frac{2}{Γ ( 1 + {y}_{k} ) Γ ( 2 - {y}_{k} )} {( {a}_{k}^{y} )}^{( {y}_{k} )} {( 1 - {a}_{k}^{y} )}^{( 1 - {y}_{k} )} & ( 1.4 ) \\ = \begin{matrix}ln 2 - ln Γ ( 1 + {y}_{k} ) - ln Γ ( 2 - {y}_{k} ) + \\ {y}_{k} ln {a}_{k}^{y} + ( 1 - {y}_{k} ) ln ( 1 - {a}_{k}^{y} )\end{matrix} & ( 1.5 ) \\ = ψ ( {y}_{k} ) + {y}_{k} ln {a}_{k}^{y} + ( 1 - {y}_{k} ) ln ( 1 - {a}_{k}^{y} ) & ( 1.6 )\end{matrix}\end{matrix} \qquad ( 1.3 )$$

where ψ(γₖ)=ln2−lnΓ(1+γₖ)−lnΓ(2+γₖ). Then the negative log-likelihood simplifies as

$$\begin{matrix}- l ( {y}_{k} \vert x , θ , ϕ ) = - ln p ( {y}_{k} \vert x , θ , ϕ ) & \\ = - ψ ( {y}_{k} ) - {y}_{k} ln {a}_{k}^{y} - ( 1 - {y}_{k} ) ln ( 1 - {a}_{k}^{y} ) & ( 1.8 ) \\ = - ψ ( {y}_{k} ) + ε ( {y}_{k} , {a}_{k}^{y} , θ , ϕ ) & ( 1.9 )\end{matrix} \qquad ( 1.7 )$$

where ε(γₖ, aₖ^{y}, θ, ϕ) is the double cross-entropy between Yₖ and aₖ^{y}.

Unidirectional or ordinary backpropagation (BP) trains the AE. This gradient method finds the model weights θ* and ϕ* that locally maximize the decoder's output likelihood. This just minimizes the double cross-entropy:

$$\begin{matrix}{θ}^{*} , {ϕ}^{*} = arg {max}_{θ , ϕ} p ( y \vert x , θ , ϕ ) & \\ = arg {max ln}_{θ , ϕ} p ( y \vert x , θ , ϕ ) & ( 1.11 ) \\ = arg {max}_{θ , ϕ} - ln p ( y \vert x , θ , ϕ ) & ( 1.12 ) \\ = arg {max}_{θ , ϕ} ε ( y , {a}^{y} , θ , ϕ ) & ( 1.13 )\end{matrix} \qquad ( 1.1 )$$

because the logarithm is a monotonic function and because −ψ(γₖ) does not depend on θ or ϕ.

Unidirectional BP trains on only the forward error ε(γₖ, a^{y}, θ, ϕ) over M training samples {x^{(m)}}ₘ₌₁^{M}. This forward error simplifies as

$$\begin{matrix}{ε}_{ℳ} ( y , {a}^{y} , θ , ϕ ) = {\sum }_{m = 1}^{M} ε ( {y}^{( m )} , {a}^{{y}^{( m )}} , θ , ϕ ) & \\ = {\sum }_{m = 1}^{M} {\sum }_{k = 1}^{K} ε ( {y}_{k}^{( m )} , {a}_{k}^{{y}^{( m )}} , θ , ϕ ) & ( 1.15 ) \\ = \begin{matrix}- {\sum }_{m = 1}^{M} {\sum }_{k = 1}^{K} ( {y}_{k}^{( m )} ln ( {a}_{k}^{{y}^{( m )}} ) ) + \\ ( 1 - {y}_{k}^{( m )} ) ln ( 1 - {a}_{k}^{{y}^{( m )}} ) .\end{matrix} & ( 1.16 )\end{matrix} \qquad ( 1.14 )$$

The corresponding log-likelihood is

$$\begin{matrix}ln {p}_{M} ( y \vert x , θ , ϕ ) = ln {\prod }_{m = 1}^{M} p ( {y}^{( m )} \vert {x}^{( m )} , θ , ϕ ) & \\ = {\sum }_{m = 1}^{M} ln {\prod }_{k = 1}^{K} p ( {y}_{k}^{( m )} \vert {x}^{( m )} , θ , ϕ ) & ( 1.18 ) \\ = {\sum }_{m = 1}^{M} {\sum }_{k = 1}^{K} ln p ( {y}_{k}^{( m )} \vert {x}^{( m )} , θ , ϕ ) & ( 1.19 ) \\ = \begin{matrix}{\sum }_{m = 1}^{M} {\sum }_{k = 1}^{K} ( ln 2 - ln Γ ( 1 + {y}_{k}^{( m )} ) + \\ ( 1 - {y}_{k}^{( m )} ) ln ( 1 - {a}_{k}^{{y}^{( m )}} )\end{matrix} & ( 1.2 )\end{matrix} \qquad ( 1.17 )$$

where yₖ^{(m)} is the target at the k^{th} output neuron and where aₖ^{y(m)} is the activation of the k^{th} neuron at the output layer of the decoder. Note that yₖ^{(m)}=xₖ^{(m)} because the autoencoder approximates an identity map.

### 1.3. Bidirectional Autoencoders

A bidirectional network runs forward and backward through the same synaptic weights [23], [29]-[31]. A forward inference passes through a given rectangular weight matrix W while the backward inference passes through the matrix transpose W^{T}.

A BAE N_{θ} learns or approximates an identity mapping from an input pattern space to the same or similar output pattern space. The data-encoding from the pattern x to the latent variable z passes forward through the network N_{θ}. The encoding of the input image gives

a^{z}=N_{θ}(x). (1.21)

The decoding from z back to x passes backwards through the same network. So, the encoded message decodes as

aₓ^{b}=N_{θ}^{T}(a^{z}). (1.22)

BAE networks train with a form of the bidirectional backpropagation algorithm [23], [30]. This training maximizes the backward likelihood p(x|y, θ) of the bidirectional networks. So this bidirectional structure differs in kind from the encoder-only structure of the Bidirectional Encoder Representations from Transformers (BERT) model [32].

The training error function ε_{M}(x, θ) equals the negative log-likelihood of M training samples with the assumption of independent and identical distribution. The negative loglikelihood of Beta(α=1+xₖ, β=2−xₖ) gives the cross-entropy:

$$\begin{matrix}{ε}_{ℳ} ( x , θ ) = = \begin{matrix}- \frac{1}{M} {\sum }_{m = 1}^{M} ( {x}^{( m ) T} ln ( {a}^{x b ( m )} ) ) + \\ {( 1 - {x}^{( m )} )}^{T} ln ( 1 - {a}^{x b ( m )} )\end{matrix} & \\ = \begin{matrix}- \frac{1}{M} {\sum }_{m = 1}^{M} {\sum }_{i = 1}^{I} ( {x}_{i}^{( m )} ln ( {a}_{i}^{{xb}^{( m )}} ) ) + \\ ( 1 - {x}_{i}^{( m )} ) ln ( 1 - {a}_{i}^{x b ( m )} )\end{matrix} & ( 1.24 )\end{matrix} \qquad ( 1.23 )$$

where xᵢ^{(m)} is the i^{th} pixel value of the m^{th} sample. The term xaᵢ^{xb(m)} is the activation of the i^{th} input neuron on the backward pass of the m^{th} sample.

Overall: BAE networks significantly reduced memory usage because they reduced the number of synaptic parameters by about 50%. This favors both large-scale neural models and dedicated hardware implementations.

### 1.4. Simulation Results

The supercomputer simulations compared the performance of unidirectional with bidirectional AEs. They tested these autoencoders on image compression and reconstruction and on image denoising.

### A. Model Architecture

Two types of autoencoders were tested. The AEs were either fully connected or convolutional. The models used the new logistic nonvanishing (NoVa) hidden neurons [33], [34] because NoVa neurons outperformed rectified linear unit (ReLU) neurons and many others. The NoVa activation perturbs a logistic where the activation a(x) from input x is

$$a ( x ) = b x + x σ ( c x ) = b x + \frac{x}{1 + exp ( - c x )} . \qquad ( 1.25 )$$

where b=0.3 and c=2.0 were used
1) Fully Connected Autoencoder: The unidirectional AEs with fully connected layers each used one encoder network and one decoder network. Each encoder used four fully connected hidden layers. The first two hidden layers used 1000 neurons per layer and the other two used 500 neurons per layer. The encoder used identity input activations and sigmoid outputs.

Each decoder network mirrored the encoder and used four fully connected hidden layers. The first two hidden layers used 500 neurons per layer and the other two used 1000 neurons per layer.

BAEs with fully connected layers each used one bidirectional network. Each bidirectional network used four fully connected hidden layers. The first two hidden layers used 1000 neurons per layer and the other two used 500 neurons per layer.
2) Convolutional Autoencoders: The unidirectional convolutional AEs each used a convolutional encoder network and a convolutional decoder network. Each convolutional encoder network used five convolutional layers and two fully connected layers for encoding. The dimensions of the respective input channels and output channels of the convolutional layers were (3, 32, 64, 128, 256) and (32, 64, 128, 256, 512). The two fully connected layers used 2048 neurons and 1024 neurons.

The convolutional decoder network used five convolutional layers and two fully connected layers for decoding. The dimensions of the respective input channels and output channels of the convolutional layers were (512, 256, 128, 64, 32) and (256, 128, 64, 32, 3). The two fully connected layers used 2048 neurons and 1024 neurons.

The bidirectional convolutional AEs used a bidirectional convolutional network for encoding and decoding. Each BAE used five convolutional layers and two fully connected layers. The dimensions of the respective input channels and output channels of the convolutional layers were (3, 32, 64, 128, 256) and (32, 64, 128, 256, 512). The two fully connected layers used 2048 neurons and 1024 neurons. The convolutional autoencoders trained over 300 epochs.

### B. Datasets

AEs and BAEs were compared on the MNIST handwritten digit, and the CIFAR-10 image dataset [35]. The MNIST handwritten digit dataset contained the 10 classes of the handwritten digits {0, 1, 2, 3, 4, 5, 6; 7, 8, 9}. This dataset set consisted of 60,000 training samples with 6,000 samples per class and 10,000 test samples with 1,000 samples per class.

The CIFAR-10 test set consists of 60,000 color images from 10 categories (K=10). Each image had size 32×32×3. The 10 pattern categories were airplane, automobile, bird, cat, deer, dog, frog, horse, ship, and truck. Each class consisted of 5,000 training samples and 1,000 testing samples.

The denoising experiments used noise-corrupted input images. The additive-noise denoising used noisy input images x=y+n where n that came from the Gaussian probability density N(μ=0; σ) for clean image y. The multiplicative (speckle) noise denoising models used the noisy input image x=y*n where n came from N (μ=0; σ).

### C. Results

BAEs outperformed unidirectional AEs on image compression and image denoising. BAEs also reduced the number of parameters by about 50%. The simulations used two performance metrics: peak signal-to-noise ratio (PSNR) and structural similarity index measure (SSIM) [36].

The simulations showed that fully connected BAEs outperformed fully connected unidirectional AEs on both metrics. BAEs also reduced the number of trainable parameters by about 50%. The simulations found these bidirectional benefits for image compression on the digit MNIST handwritten dataset. FIG. 5 shows the bidirectional benefits of an increase in PSNR on image compression and image denoising (additive and multiplicative). The simulations used four different dimensions for the latent variable. FIG. 5a compares the BAEs with unidirectional AEs. Table 1.1 shows the bidirectional benefits in PSNR and in the reduced number of network parameters. These bidirectional benefits also extended to image denoising.

FIG. 5b shows that BAEs performed better than unidirectional AEs on denoising additive Gaussian noise. FIG. 5c shows a similar bidirectional benefit for denoising when the contaminating noise was multiplicative Gaussian noise. FIG. 6 shows that the compressed features from BAEs can be more easily separated compared to those from unidirectional AEs. This favors BAEs for extracting discriminative features for recognition or classification.

The t-distributed stochastic neighbor embedding (t-SNE) method was used to visualize the encoded features. This method uses a statistical approach to map the high-dimensional representation of data {xᵢ}ᵢ₌₁^{N} to their respective low-dimensional representation {yᵢ}ᵢ₌₁^{N} based on the similarity of the datapoints [24]. It is a two-step method. The first step defines the conditional probability p_{j|i} and the joint probability pᵢⱼ over the high-dimensional space. The conditional probability is proportional to the similarity between xᵢ and xⱼ. It uses a Gaussian probability density with mean xᵢ:

$${p}_{j \vert i} = \frac{exp ( - {\vert {x}_{i} - {x}_{j} \vert}^{2} / 2 {σ}_{i}^{2} )}{{\sum }_{k \neq i} exp ( - {\vert {x}_{i} - {x}_{k} \vert}^{2} / 2 {σ}_{i}^{2} )} \qquad ( 1.26 )$$

for all j≠i where σᵢ is the variance of the Gaussian with mean x₁. The term p_{i|i}=0. The joint probability is

$${p}_{i j} = \frac{{p}_{j \vert i} + {p}_{i \vert j}}{2 N} \qquad ( 1.27 )$$

where N is the number of datapoints.

The second step maps the high-dimensional representation x₁ to its corresponding low-dimensional representation yᵢ in [symbol] (d is typically 2 or 3). It uses a heavy-tailed student's-t density with one-degree of freedom (which equals the Cauchy density) to model the low-dimensional joint distribution. So, the joint probability qᵢⱼ of the low-dimensional representations yᵢ and yⱼ has the form:

$${q}_{i j} = \frac{{( 1 + {‖ {y}_{i} - {y}_{j} ‖}^{2} )}^{- 1}}{{\sum }_{k} {\sum }_{l \neq k} {( 1 + \vert {‖ {y}_{k} - {y}_{l} ‖}^{2} )}^{- 1}} \qquad ( 1.28 )$$

for all i≠j and qᵢᵢ=0. The location of the low-dimension representation comes from minimizing the Kullback-Leibler divergence

$$K L ( P \vert Q ) = {\sum }_{i \neq j} {p}_{ij} log \frac{{p}_{ij}}{{q}_{ij}} . \qquad ( 1.29 )$$

The t-SNE algorithm uses gradient descent to iteratively find the value of γᵢ that minimizes the KL(P∥Q).

Simulations also showed that convolutional BAEs outperformed convolutional unidirectional AEs on the CIFAR-10 dataset. Table 1.3 shows that convolutional BAEs slightly outperformed their corresponding unidirectional architecture for image compression. This included a slight increase in the PSNR and the SSIM as well as a reduction of about 50% in the number of parameters. Table 1.4 shows a similar bidirectional benefit of a slight increase in the PSNR and a slight increase in the SSIM for the image denoising task.

### V. Conclusions

Bidirectional autoencoders offer an efficient way to learn autoencoder mappings. The new bidirectional backpropagation algorithm allows a single network to perform encoding and decoding. The bidirectional architecture improved network performance and reduced computing memory because it cut in half the number of trainable synaptic parameters. So, it should have more pronounced bidirectional benefits on larger-scale models and aid hardware implementations. Preliminary simulations also found that these bidirectional benefits extended to variational autoencoders.

### 2. Bidirectional Variational Autoencoders

### 2.1. Overview of Bidirectional Variational Autoencoders

This section introduces the new bidirectional variational autoencoder (BVAE) network. This architecture uses a single parametrized network for encoding and decoding. It trains with the new bidirectional backpropagation algorithm that jointly optimizes the network's bidirectional likelihood [37], [38]. The algorithm uses the same synaptic weights both to predict the target y given the input x and to predict the converse x given y. Ordinary or unidirectional VAEs use separate networks to encode and decode.

Unidirectional variational autoencoders (VAEs) are unsupervised machine-learning models that learn data representations [39], [40]. They both learn and infer with directed probability models that often use intractable probability density functions [41]. A VAE seeks the best estimate of the data likelihood p(x|θ) from samples {x(n)}ₙ₌₁^{N} if x depends on some observable feature z and if θ represents the system parameters. The intractability involves marginalizing out the random variable z to give the likelihood p(x|θ):

$$p ( x \vert θ ) = {E}_{z \vert θ [ p ( x \vert z , θ ) ]} = {\int }_{Z} p ( x \vert z , θ ) p ( z \vert θ ) dz . \qquad ( 2.1 )$$

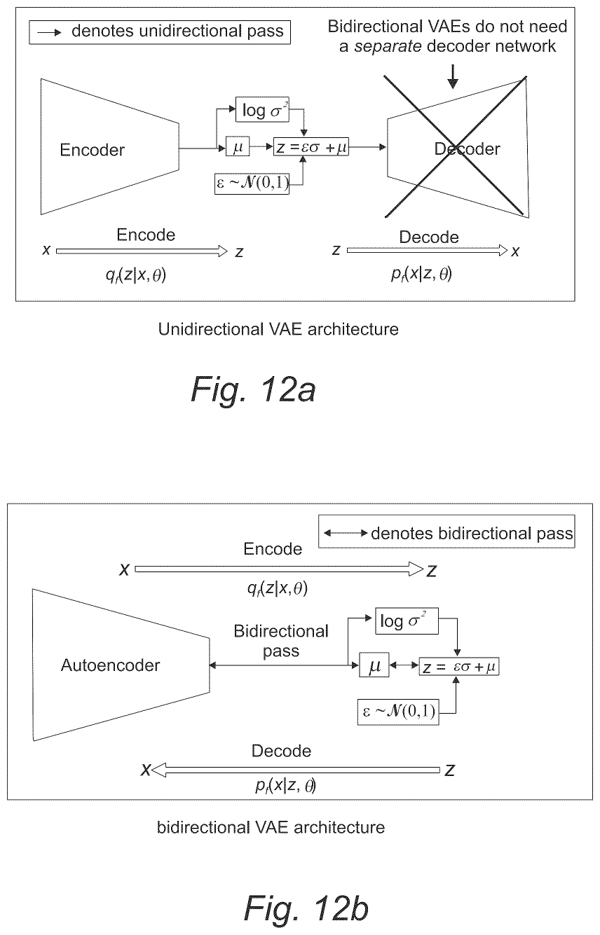

Kingma and Welling introduced VAEs to solve this computational problem [41]. The VAE includes a new recognition (or encoding) model q(z|x, ϕ) that approximates the intractable likelihood q(z|x, θ). The probability q(z|x, ϕ) represents a probabilistic encoder while p(x|z, θ) represents a probabilistic decoder. These probabilistic models use two neural networks i-th different synaptic weights. FIG. 12a shows the architecture of such a unidirectional VAE. The recognition model doubles the number of parameters and the computational cost of this solution. The new bidirectional backpropagation (B-BP) algorithm trains a neural network to run forwards and backwards by jointly maximizing the respective directional probabilities. This among other things allows such a network to run backward from output code words to expected input patterns. Running a unidirectionally trained network backwards just produces noise. B-BP jointly maximizes the forward likelihood q_{f}(z|x, θ) and backward likelihood p_{b}(x|z, θ) or the equivalent sum of their respective log-likelihoods:

$$\begin{matrix}{θ}^{*} = arg {max}_{θ} {q}_{f} ( z \vert x , θ ) {p}_{b} ( x \vert z , θ ) & \\ = arg max {\underbrace{ln {q}_{f} ( z \vert x , θ )}}_{Forward pass} + {\underbrace{ln {p}_{b} ( x \vert z , θ ) .}}_{Backward pass} & 2.3\end{matrix} \qquad 2.2$$

A BVAE approximates the intractable q(z|x, θ) with the forward likelihood q_{f}(z|x, θ). Then the probabilistic encoder is q_{f}(z|x, θ)) and the probabilistic decoder is P_{b}(x|z, θ). So the two densities share parameter θ and there is no need for a separate network. FIG. 12b shows the architecture of a BVAE.

VAEs vary based on the choice of latent distribution, the method of training, and the use of joint modeling with other generative models, among other factors. The β-VAE introduced the adjustable hyperparameter β. It balances the latent channel capacity of the encoder network and the reconstruction error of the decoder network [42]. It trains on a weighted sum of the reconstruction error and the Kullback-Leibler divergence D_{KL}(q(z|x, ϕ)∥p(z|θ)). The β-TCVAE (Total Correlation Variational Autoencoder) extends β-VAE to learning isolating sources of disentanglement [43]. A disentangled β-VAE modifies the β-VAE by progressively increasing the information capacity of the latent code while training [44].

Importance weighted autoencoders (IWAEs) use priority weights to derive a strictly tighter lower bound on the loglikelihood [45]. Variants of IWAE include the partially importance weighted auto-encoder (PIWAE), the multiply importance weighted auto-encoder (MIWAE), and the combined importance weighted auto-encoder (CIWAE) [46].

Hyperspherical VAEs use a non-Gaussian latent probability density. They use a von Mises-Fisher (vMF) latent density that gives in turn a hyperspherical latent space [40]. Other VAEs include the Consistency Regularization for Variational AutoEncoder (CRVAE) [39], the InfoVAE [47], and the Hamiltonian VAE [48] and so on. All these VAEs use separate networks to encode and decode.

Vincent et alia [49] suggests the use of tied weights in stacked autoencoder networks. This is a form of constraint that parallels the working of restricted Boltzmann machines RBMs [50] and thus a simple type of bidirectional associative memory or BAM [51]. It forces the weights to be symmetric using W^{T} on the backward pass. The building block here is a shallow network with no hidden layer [52], [53]. They further suggest that combining this constraint with a nonlinear activation would lead to poor reconstruction error.

Bidirectional autoencoders BAEs [54] extend bidirectional neural representations to image compression and denoising. BAEs differ from autoencoders with tied weights because they relax the constraint by extending the bidirectional assumption over the depth of a deep network. BAEs differ from bidirectional VAEs because they do not require the joint optimization of the directional likelihoods. This limits the generative capability of BAEs.

The next sections review ordinary VAEs and introduce probabilistic BVAEs using the new B-BP algorithm. Section IV compares them on the four standard image test datasets: MNIST handwritten digits, Fashion-MNIST, CIFAR-10, and CelebA-64 datasets. It was found that BVAEs cut the number of tunable parameters in half while still performing slightly better than the unidirectional VAEs.

### 2.2. Unidirectional Variational Autoencoders

Let p(x|θ) denote the data likelihood and z denote the hidden variable. The data likelihood simplifies as

$$p ( x \vert θ ) = \frac{p ( x , z \vert θ )}{q ( z \vert \vert x , θ )} = \frac{p ( x \vert z , θ ) p ( z \vert θ )}{q ( z \vert x , θ )} . \qquad 2.4$$

The likelihood q(z|x, θ) is intractable to solve. So unidirectional VAEs introduce a new likelihood that represents the recognition or encoding model. The term q_{f}(z|x, ϕ) represents the forward likelihood of the encoding network that approximates the intractable likelihood q(z|x, θ):

$$p ( x \vert θ ) = \frac{p ( x \vert z , θ ) p ( z \vert θ )}{q ( z \vert x , θ )} = \frac{p ( x \vert z , θ ) p ( z \vert θ ) {q}_{f} ( z \vert x , ϕ )}{q ( z \vert x , θ ) {q}_{f} ( z \vert x , ϕ )} . \qquad 2.5$$

The corresponding data log-likelihood ln p(x|θ) is

$$ln p ( x \vert θ ) = ln [ \frac{p ( x \vert z , θ ) p ( z \vert θ ) {q}_{f} ( z \vert x , ϕ )}{q ( z \vert x , θ ) {q}_{f} ( z \vert x , ϕ )} ] . \qquad 2.6$$

$$= ln p ( x \vert z , θ ) + ln \frac{p ( z \vert θ )}{{q}_{f} ( z \vert x , ϕ )} + ln \frac{{q}_{f} ( z \vert x , ϕ )}{q ( z \vert x , θ )} . \qquad 2.7$$

$$= ln p ( x \vert z , θ ) - ln \frac{{q}_{f} ( z \vert x , ϕ )}{p ( z \vert θ )} + ln \frac{{q}_{f} ( z \vert x , ϕ )}{q ( z \vert x , θ )} . \qquad 2.8$$

Now take the expectation of (8) with respect to q_{f}(z|x, θ):

$${E}_{z \vert x , ϕ} [ ln p ( x \vert θ ) ] = {\int }_{z} {q}_{f} ( z \vert x , ϕ ) ln p ( x \vert θ ) dz . \qquad 2.9$$

$$= ln p ( x \vert θ ) {\int }_{z} {q}_{f} ( z \vert x , ϕ ) dz . \qquad 2.1$$

$$= ln p ( x \vert θ ) \qquad 2.11$$

because q_{f}(z|x, θ) is a probability density function and its integral over the domain of z equals 1. The expectation of the term on the right-hand side of (8) with respect q_{f}(z|x, θ) is

$${E}_{z \vert x , ϕ} [ ln p ( x \vert z , θ ) - ln \frac{{q}_{f} ( z \vert x , ϕ )}{p ( z \vert θ )} + ln \frac{{q}_{f} ( z \vert x , ϕ )}{q ( z \vert x , θ )} ] = {E}_{z \vert x , θ [ 𝕝𝕟 p ( x \vert z , θ ) ]} - {D}_{KL} ( {q}_{f} ( z \vert x , ϕ ) ‖ p ( z \vert θ ) ) + {D}_{KL} ( {q}_{f} ( z \vert x , ϕ ) ‖ q ( z \vert x , θ ) ) \qquad 2.12$$

$$where$$

$${D}_{KL} ( {q}_{f} ( z \vert x , ϕ ) ‖ p ( z \vert θ ) ) = {E}_{z \vert x , ϕ} [ ln \frac{{q}_{f} ( z \vert x , ϕ )}{p ( z \vert θ )} ] \qquad 2.13$$

$$and$$

$${D}_{KL} ( {q}_{f} ( z \vert x , ϕ ) ‖ q ( z \vert x , θ ) ) = {E}_{z \vert x , ϕ} [ ln \frac{{q}_{f} ( z \vert x , ϕ )}{p ( z \vert θ )} ] . \qquad 2.14$$

Combining (8), (9), and (12) gives

$$p ( x \vert θ ) = {\underbrace{{E}_{z \vert x , ϕ} [ ln p ( x \vert z , θ ) ]}}_{Decoding} - {\underbrace{{D}_{KL} ( {q}_{f} ( z \vert x , θ ) ‖ q ( z \vert x , θ ) )}}_{Encoding} ++ {\underbrace{{D}_{KL} ( {q}_{f} ( z \vert x , θ ) \vert q ( z \vert x , θ ) ) .}}_{Error - gap} \qquad 2.15$$

The KL-divergence between q_{f}(z|x, θ) and q(z|x, θ) yields the following inequality because of Jensen's inequality:

$${D}_{KL} ( {q}_{f} ( z \vert x , ϕ ) \vert q ( z \vert x , θ ) ) = {E}_{z \vert x , ϕ} [ \frac{{q}_{f} ( z \vert x , ϕ )}{q ( z \vert x , θ )} ] \qquad 2.16$$

$$= {\int }_{z} {q}_{f} ( z \vert x , ϕ ) ln \frac{{q}_{f} ( z \vert x , θ )}{{q}_{f} ( z \vert x , θ )} dz \qquad 2.17$$

$$= - {\int }_{z} {q}_{f} ( z \vert x , ϕ ) ln \frac{q ( z \vert x , θ )}{{q}_{f} ( z \vert x , θ )} \qquad 2.18$$

$$\geq - ln {\int }_{z} q ( z \vert x , θ ) \qquad 2.19$$

$$= - {\int }_{z} q ( z \vert x , θ ) dz \qquad 2.2$$

$$= - ln 1 = 0 \qquad 2.21$$

because the negative of the natural logarithm is convex. So

$$ln p ( x \vert θ ) \geq {E}_{z \vert x , ϕ} [ ln p ( x \vert z , θ ) ] - {D}_{KL} ( {q}_{f} ( z \vert x , ϕ ) ‖ p ( z \vert x , θ ) ) \qquad 2.22$$

$$and$$

$$ℒ ( x , θ , ϕ ) = {E}_{z \vert x , ϕ} [ ln p ( x \vert z , θ ) ] - {D}_{KL} ( {q}_{f} ( z \vert x , ϕ ) \vert p ( z \vert x , θ ) ) \qquad 2.23$$

where [symbol] (x, θ, ϕ) is the evidence lower bound (ELBO) on the data log-likelihood p(x|θ).

Unidirectional VAEs train on the estimate [symbol] (x, θ, ϕ) of the ELBO using ordinary or unidirectional backpropagation (BP). This estimate involves using the forward pass q(z|x, ϕ) to approximate the intractable encoding model q(z|x, θ) and the forward pass p_{f}(x|z, θ) to approximate the encoding model. The gradient update rules for the encoder and decoder networks at the (n+1)^{th} iteration or training epoch are

$${θ}^{( n + 1 )} = {θ}^{( n )} + η {∇}_{θ} {\tilde{ℒ}}_{ELBO} ( x , θ , ϕ ) {\vert}_{θ = {θ}^{( n )} , ϕ = {ϕ}^{( n )}} \qquad 2.24$$

$${ϕ}^{( n + 1 )} = {ϕ}^{( n )} + η {∇}_{θ} {\tilde{ℒ}}_{ELBO} ( x , θ , ϕ ) {\vert}_{θ = {θ}^{( n )} , ϕ = {ϕ}^{( n )}} \qquad 2.25$$

where η is the learning rate, ϕ⁽ⁿ⁾) is the encoder parameter, and θ⁽ⁿ⁾ is the decoder parameter after n training iterations.

### 2.3. Bidirectional Variational Autoencoders

Bidirectional VAEs use the directional likelihoods of a network with parameter θ to approximate the data log-likelihood ln p(x|θ). They use the same bidirectional associative network to model the encoding and decoding phases. The forward-pass likelihood q_{f}(z|x, θ) models the encoding and the backward pass likelihood p_{b}(x|z, θ) models the decoding. So BVAEs do not need an extra likelihood q(z|x, ϕ) or an extra network with parameter ϕ.

The data log-likelihood is

$$p ( x \vert θ ) = \frac{p ( x \vert z , θ ) p ( z \vert θ )}{q ( z \vert x , θ )} . \qquad 2.26$$

$$then$$

$$ln p ( x \vert θ ) = ln [ \frac{p ( x \vert z , θ ) p ( z \vert θ )}{q ( z \vert x , θ )} ] \qquad 2.27$$

$$ln [ \frac{p ( x \vert z , θ ) p ( z \vert θ ) {q}_{f} ( z \vert x , θ )}{q ( z \vert x , θ ) {q}_{f} ( z \vert x , θ )} ] \qquad 2.28$$

$$= ln [ p ( x \vert z , θ ) ] - ln [ \frac{{q}_{f} ( z \vert x , θ )}{p ( z \vert x , θ )} ]$$

$$+ [ ln \frac{{q}_{f} ( z \vert x , θ )}{p ( z \vert x , θ )} ] . \qquad 2.29$$

Now take the expectation of (29) with respect to q_{f}(z|x, θ) and consider the left-hand side of (29):

$${E}_{z \vert x , θ} [ ln p ( x \vert z , θ ) ] = {\int }_{z} {q}_{f} ( z \vert x , θ ) ln p ( x \vert θ ) dz \qquad 2.3$$

$$= ln p ( x \vert θ ) {\int }_{z} {q}_{f} ( z \vert x , θ ) dz \qquad 2.31$$

$$= ln p ( x \vert θ ) . \qquad 2.32$$

The expectation of the right-hand term is

$${E}_{z \vert x , θ} [ ln p ( x \vert z , θ ) - [ ln \frac{{q}_{f} ( z \vert x , θ )}{p ( z \vert θ )} + ln \frac{{q}_{f} ( z \vert x , θ )}{q ( z \vert x , θ )} ] = {E}_{z \vert x , θ} [ ln p ( x \vert z , θ ) ] - {D}_{KL} ( {q}_{f} ( z \vert x , θ ) \vert p ( z \vert θ ) ) + {D}_{KL} ( {q}_{f} ( z \vert x , θ ) \vert q ( z \vert θ ) ) \qquad 2.33$$

$$where$$

$${E}_{z \vert x , θ} [ ln \frac{{q}_{f} ( z \vert x , θ )}{p ( z \vert θ )} ] = {D}_{KL} ( {q}_{f} ( z \vert x , θ ) \vert p ( z \vert θ ) ) \qquad 2.34$$

$$and$$

$${E}_{z \vert x , θ} [ ln \frac{{q}_{f} ( z \vert x , θ )}{q ( z \vert x , θ )} ] = {D}_{KL} ( {q}_{f} ( z \vert x , θ ) \vert q ( z \vert x , θ ) ) \qquad 2.35$$

The corresponding data log-likelihood of a BVAE with parameter θ is

$$ln p ( x \vert θ ) = {\underbrace{{E}_{z \vert x , ϕ} [ ln p ( x \vert z , θ ) ]}}_{Decoding} - {\underbrace{{D}_{KL} ( {q}_{f} ( z \vert x , θ ) ‖ q ( z \vert x , θ ) )}}_{Encoding} + {\underbrace{{D}_{KL} ( {q}_{f} ( z \vert x , θ ) \vert q ( z \vert x , θ ) ) .}}_{Error - gap} \qquad 2.36$$

The log-likelihood of the BVAE is such that

$$ln p ( x \vert θ ) \geq {\underbrace{{E}_{z \vert x , ϕ} [ ln p ( x \vert z , θ ) ] - {D}_{KL} ( {q}_{f} ( z \vert x , θ ) ‖ q ( z \vert x , θ ) )}}_{ℒ ( x , θ , ϕ )} \qquad 2.37$$

$$because the KL - divergence {D}_{KL} ( {q}_{f} ( z \vert x , θ ) ‖ q ( z \vert x , θ ) ) \geq 0. So$$

$$ℒ ( x , θ ) = {E}_{z \vert x , θ} [ ln p ( x \vert z , θ ) ] - {D}_{KL} ( {q}_{f} ( z \vert x , θ ) \vert p ( z \vert θ ) ) \qquad 2.38$$

where [symbol] (x, θ) is the ELBO on in p(x|θ) and the expectation E_{z|x,θ} with respect to q_{f}(z|x, θ) is taken.

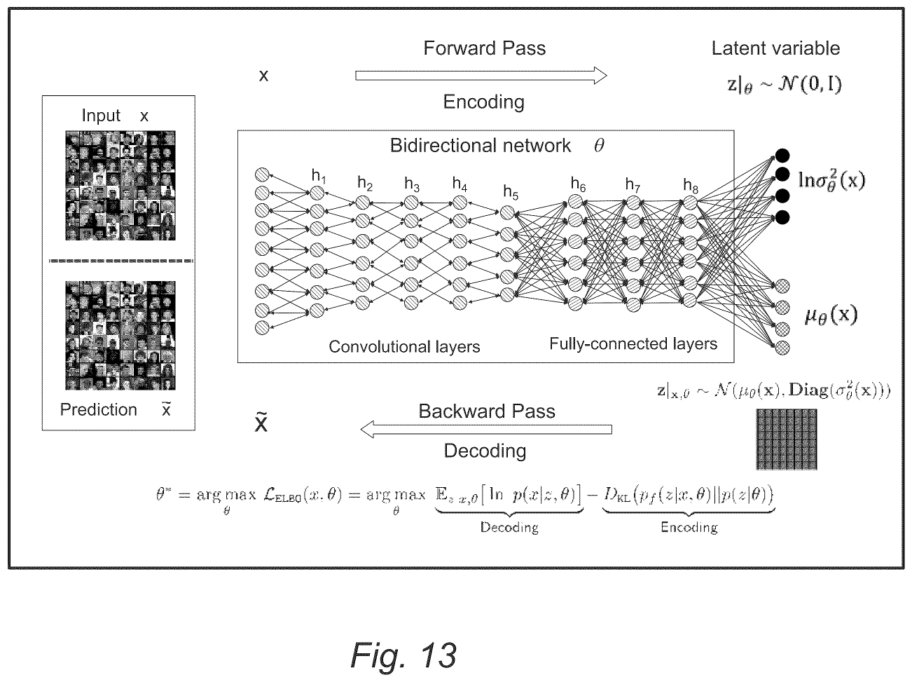

Bidirectional VAEs train on the estimate [symbol] _{ELBO} (x, θ) of the ELBO that uses bidirectional neural representation [38]. This estimate involves using the forward pass q_{f}(z|x, θ) to approximate the intractable encoding model q(z|x, θ) and the reverse pass p_{b}(x|z, θ) to approximate the decoding model. The update rule at the (n+1)^{th} iteration or training epoch is

$${θ}^{( n + 1 )} = {θ}^{( n )} + η {∇}_{θ} {\tilde{ℒ}}_{ELBO} ( x , θ ) {\vert}_{θ = {θ}^{( n )}} \qquad 2.39$$

where η is the learning rate and θ⁽ⁿ⁾ is the autoencoder network parameter just after the n^{th} training iteration. FIG. 13 shows the probabilistic approximation of a BVAE with the directional likelihoods of a bidirectional network.

### 2.4. Simulations

The performance of unidirectional VAEs and bidirectional VAEs is compared using different tasks, datasets, network architectures, and loss functions. The image test sets for the experiments are described first.

### A. Datasets

The simulations compared results on four standard image datasets: MNIST handwritten digits [55], Fashion-MNIST [56], CIFAR-10 [57], and CelebA [58] datasets.

The MNIST handwritten digit dataset contains 10 classes of handwritten digits {0, 1, 2, 3, 4, 5, 6, 7, 8, 9}. This dataset consists of 60,000 training samples with 6,000 samples per class, and 10,000 test samples with 9,000 samples per class. Each image is a single-channel image with dimension 28×28.

The Fashion-MNIST dataset is a database of fashion images. It is made of 10 classes namely ankle boot, bag, coat, dress, pullover, sandal, shirt, sneaker, trouser, and t-shirt/top. Each class has 6,000 training samples and 9,000 testing samples. Each image is also a single-channel image with dimension 28×28.

The CIFAR-10 dataset consists of 60,000 color images from 10 categories. Each image has size 32×32×3. The 10 pattern categories are airplane, automobile, bird, cat, deer, dog, frog, horse, ship, and truck. Each class consists of 5,000 training samples and 9,000 testing samples.

The CelebA dataset is a large-scale face dataset of 10, 177 celebrities [58]. This dataset is made up of 202,599 color (three-channel) images. This is not a balanced dataset. The number of Images per celebrity varies between 1-35. The dataset is divided into two splits of 9,160 celebrities for training and 9,017 celebrities for testing the VAEs. This resulted in 185,133 training samples and 17,466 testing samples. Each image is resized to 64×64×3.

### B. Tasks

The performance of bidirectional VAEs and unidirectional VAEs is compared on the following four tasks.
1) Image compression and reconstruction: The self-mapping of the image datasets with unidirectional and bidirectional VAEs was tested. This involved the encoding of images with latent variable z and the subsequent decoding to reconstruct the image after the latent sampling. The performance of VAEs were evaluated on this task using the Peak Signal-to-Noise Ratio (PSNR), Fréchet Inception Distance (FID) [59], [60], and Structural Similarity Index Measure (SSIM) [61].
2) Downstream image classification: Simple classifiers were trained on the latent space features of VAEs. These VAEs compress the input images and a simple classifier maps the latent features to their corresponding classes. The classification accuracy of this downstream classification was evaluated.

The VAE-extracted features for the MNIST handwritten dataset trained on simple linear classifiers. A neural classifier with one hidden layer of 256 logistic hidden neurons was used to classify the VAE-extracted features from the Fashion-MNIST and CIFAR-10 datasets.

The t-distributed stochastic neighbor embedding (t-SNE) method was used to visualize the reduced features. This method uses a statistical approach to map the high-dimensional representation of data {xᵢ}ᵢ₌₁^{N} to their respective low-dimensional representation {yᵢ}ᵢ₌₁^{N} based on the similarity of the datapoints [62]. This low-dimensional representation provides insight into the degree of separability among the classes.
3) Image generation: The generative performance of bidirectional VAEs were compared with their corresponding unidirectional ones. These VAEs trained with the Gaussian latent distribution N(0, I). The VAEs were tested using both Gaussian sampler and Gaussian mixture model samplers post-training [63]. The estimates of the negative of the data loglikelihood (NLL) and the number of active latent units (AU) [64] were used as the quantitative metrics for performance evaluation.
4) Image interpolation: Linear interpolation of samples was conducted. The interpolations involve a convex combination of two images over 10 steps. The encoding step transforms the mixture of two images in the latent space. The decoding step reconstructs the interpolated samples.

### C. Model Architecture

Different neural network architectures were used for various datasets and tasks.

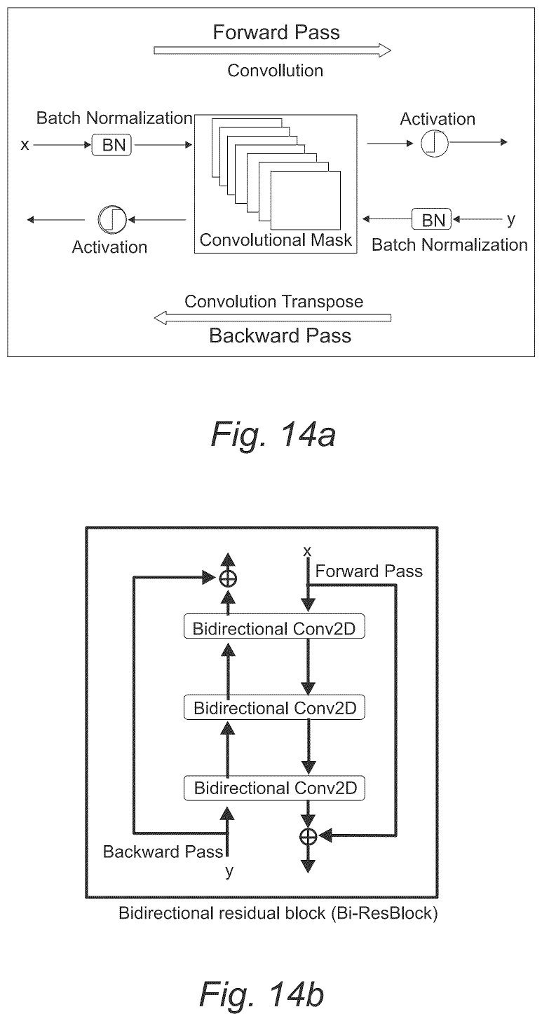

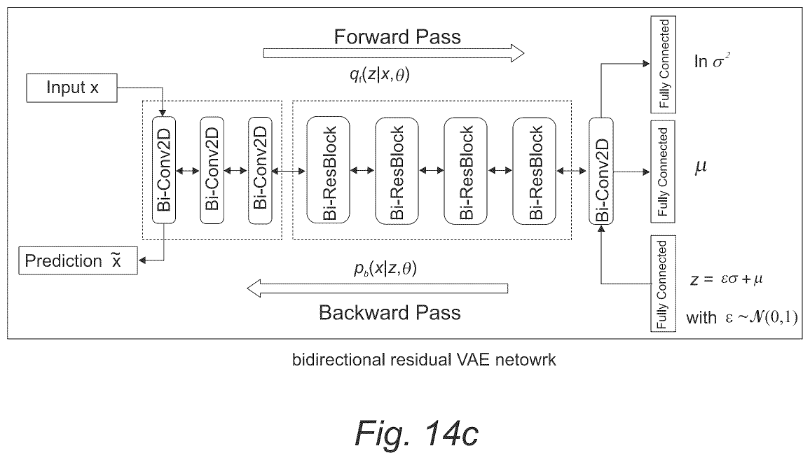

Variational Autoencoders: Deep convolutional and residual neural network architectures were used. VAEs that trained on the MNIST handwritten and Fashion-MNIST used the residual architecture. FIG. 14c shows the architecture of the bidirectional residual networks that trained on the MNIST datasets. The unidirectional VAEs with this architecture used two such networks each: one for encoding and the other for decoding. The BVAEs used just one of such network each. Encoding runs in the forward pass and decoding runs in the backward pass.

Each of the encoder and decoder networks that trained on the CIFAR-10 dataset used six convolutional layers and two fully connected layers. The corresponding BVAEs used only one network for encoding and decoding each. The dimension of the hidden convolutional layers is {64↔128↔256↔512↔1024↔2048}. The dimension of the fully connected layers is (2048 ↔1024↔0.64).

The configuration of the VAEs that trained on the CelebA dataset differs slightly. The sub-networks each used nine convolutional layers and two fully connected layers. The dimension of the hidden convolutional layers is {128↔128↔192↔256↔384↔512↔768↔1024↔1024}. The dimension of the fully connected layers is {4096↔2048↔256}.

The VAEs used generalized nonvanishing (G-NoVa) hidden neurons [65], [66]. The G-NoVa activation a(x) of input x is

$$a ( x ) = α x + x σ ( β x ) = α x + \frac{x}{1 + {e}^{- β x}}$$

where α>0 and β>0. Each layer of a BVAE performs probabilistic inference in both the forward and backward passes. The convolutional layers use bidirectional kernels. The kernels run convolution in the forward pass and transposed convolution in the backward pass. Transposed convolution projects feature maps to a higher-dimensional space [67].

Downstream Classification: Simple linear classifiers were trained on VAE-extracted features from the MNIST digit dataset. Shallow neural classifiers were trained with one hidden layer and 100 hidden neurons each on the extracted features from the Fashion-MNIST images. Similar neural classifiers with one hidden layer and 256 hidden neurons each trained on VAE extracted features from the CIFAR-10 dataset.

### D. Training

Four implementations of VAEs were considered and compares with their respective bidirectional versions. The four VAEs are vanilla VAE [41], β-VAE [42], β-TCVAE [43], and IWAE [45]. These were trained over the four datasets across the four tasks. The AdamW optimizer [68] was used with the OneCycleLR [69] learning rate scheduler. The optimizer trained on their respective ELBO estimates.

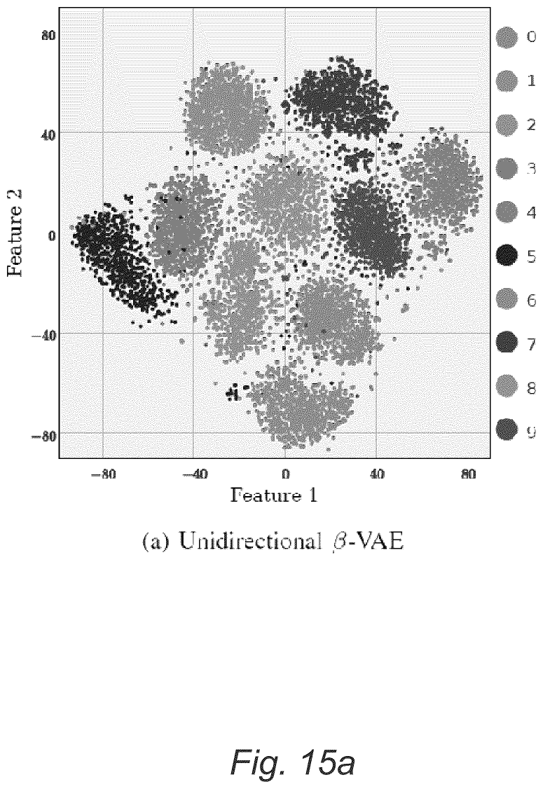

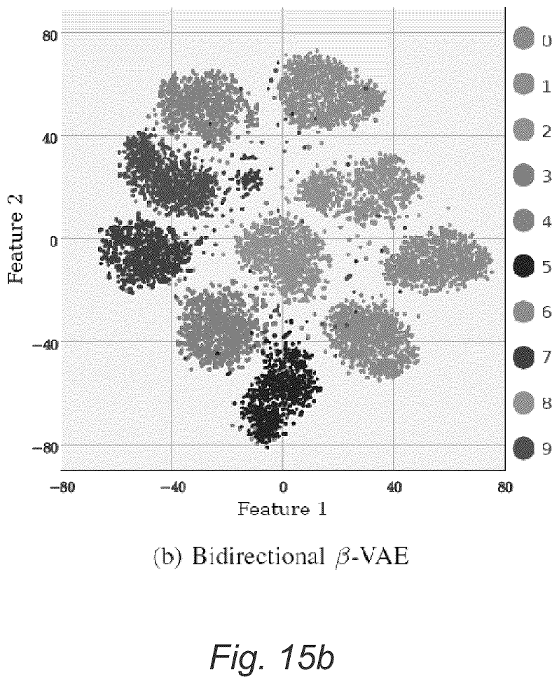

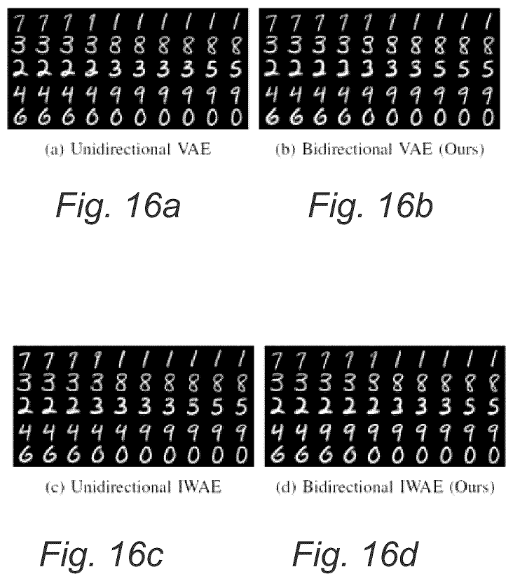

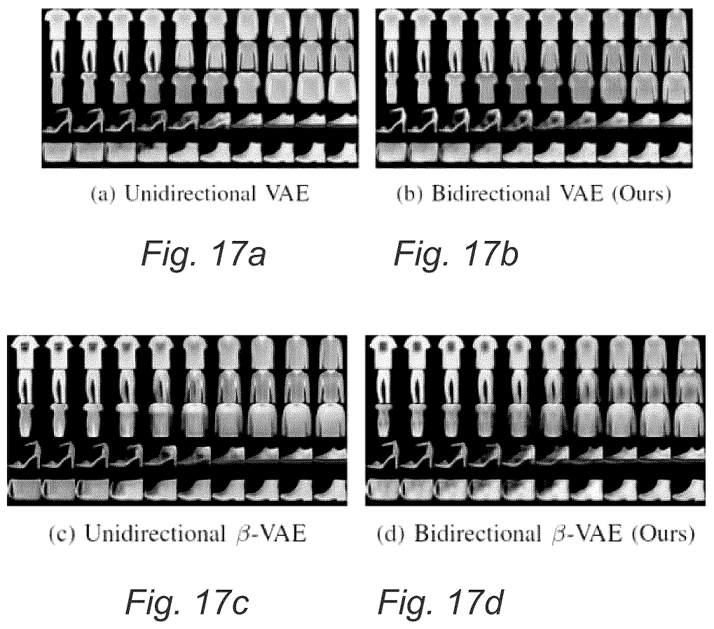

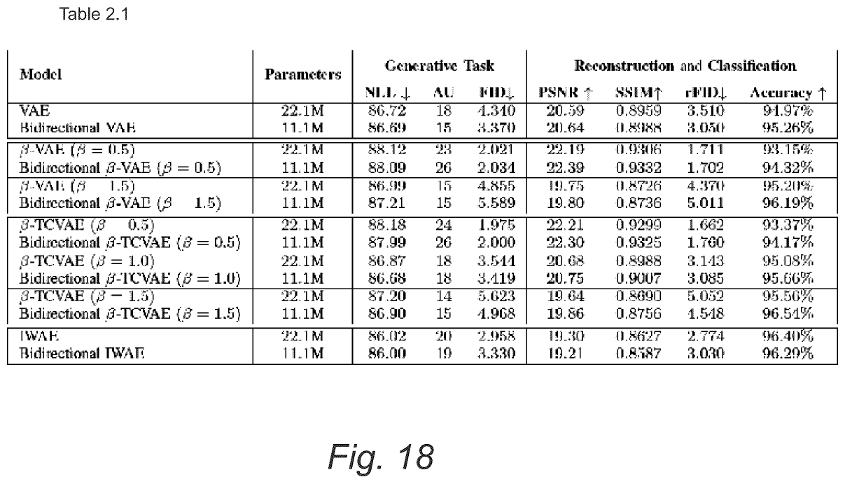

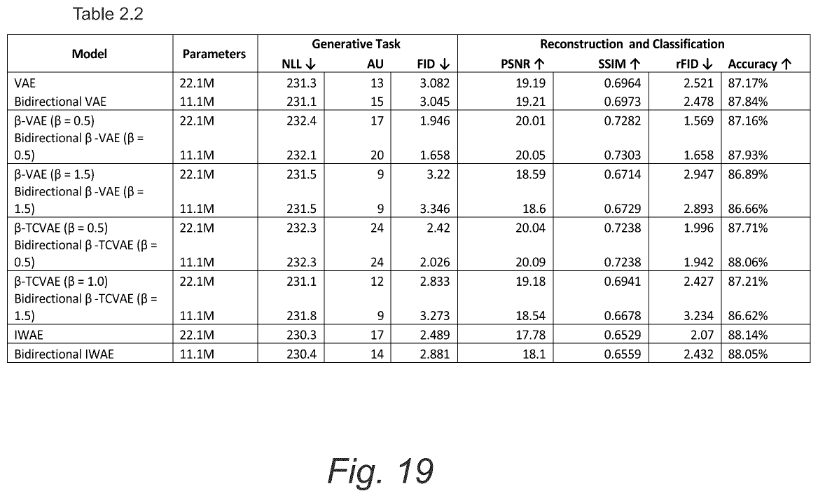

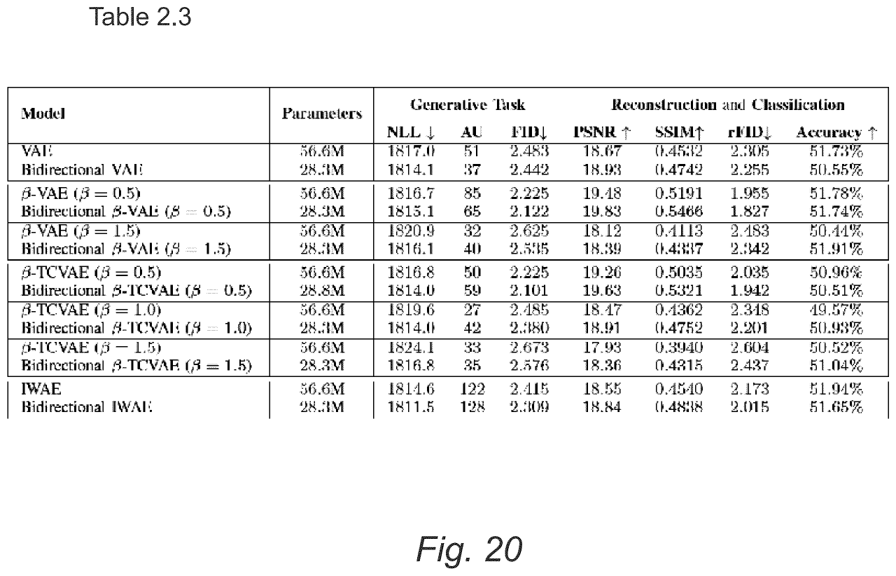

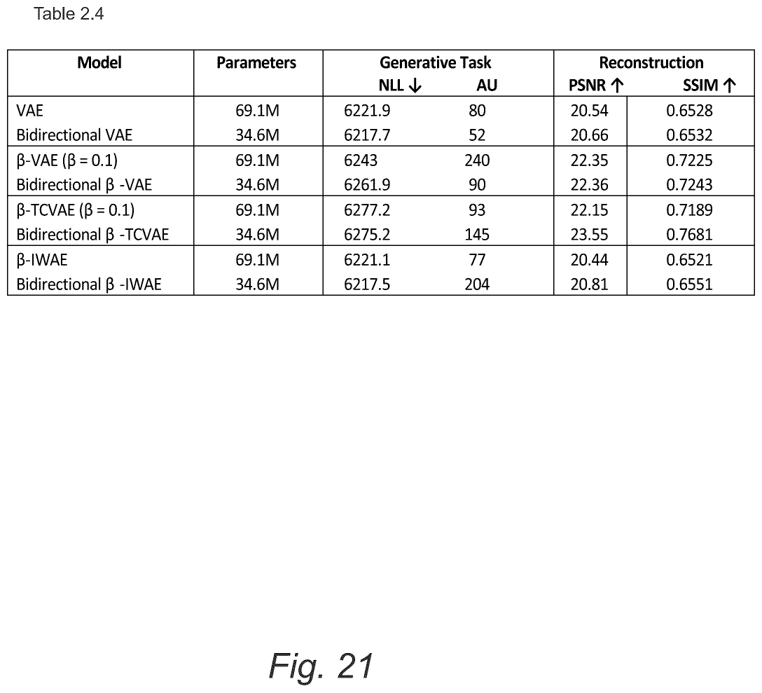

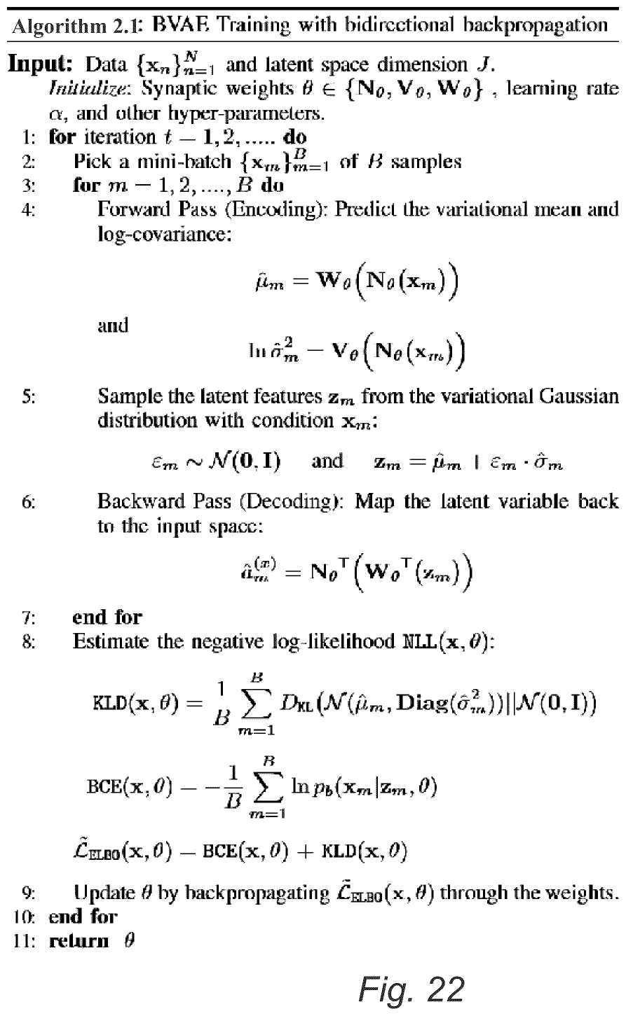

A new framework for bidirectional VAEs was designed, and unidirectional VAEs were implemented using the Pythae framework [70]. All the models trained on a single A 100 GPU. and FIGS. 15-17 and Tables 2.1-2.4 (FIGS. 18-21) present the results.

### E. Evaluation Metrics

The performance of the VAE models on generative and compression tasks was evaluated using the following quantitative metrics:
Negative Log-Likelihood (NLL): This is an estimate of the negative of in p(x|θ). This is computational intractable, so the Monte Carlo method was used to estimate this. Lower value means the model generalizes well to unseen data.
Number of Active Latent Units (AU) [64]: This reflects the number of latent variables with variance above a given threshold c. It is defined as:

$$AU = {\sum }_{d = 1}^{D} [ {Cov}_{x} [ {E}_{z \vert x , ϕ} [ {z}_{d} ] ] ] \qquad 2.41$$

where I is an indicator function, z_{d} represents the d^{th} component of the latent variable, and ϵ=0.01. Higher AU means the model uses more features for the latent space representation. But having too many active units can lead to overfitting.
Peak Signal-to-Noise Ratio (PSNR): This compares reconstructed images with their target images. Higher value implies better reconstruction from data compression.
Structural Similarity Index (SSIM): This is a perceptual metric. It quantifies the degradation from data compression. Higher SSIM value implies better reconstruction from image compression.
Downstream Classification Accuracy: This is the classification accuracy of simple classifiers that trained on the latent or VAE-extracted features. Higher accuracy means the compression extracts easy-to-classify features.
Fréchet Inception Distance (FID) [59]: This metric evaluates the quality of generated images. It measures the similarity between the distribution of real images and the distribution of generated images. Lower value implies that the generated images are closer to the real images.

### 2.5. Conclusion

Bidirectional VAEs encode and decode through the same synaptic web of a deep neural network. This bidirectional flow captures the joint probabilistic structure of both directions during learning and recall. BVAEs cut the synaptic parameter count in half compared with unidirectional VAEs. The simulations on the four image test sets showed that the BVAEs still performed slightly better than the unidirectional VAEs.

While exemplary embodiments are described above, it is not intended that these embodiments describe all forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

### REFERENCES

[1] M. Dorosti and M. M. Pedram, “Improving english to persian machine translation with GPT language model and autoencoders,” in 2023 9th International Conference on Web Research (ICWR). IEEE, 2023, pp. 214-220.
[2] D. Biesner, K. Cvejoski, and R. Sifa, “Combining variational autoencoders and transformer language models for improved password generation,” in Proceedings of the 17th International Conference on Availability, Reliability and Security, 2022, pp. 1-6.
[3] T. Ge, J. Hu, X. Wang, S.-Q. Chen, and F. Wei, “In-context autoencoder for context compression in a large language model,” arXiv preprint arXiv:2307.06945, 2023.
[4] W. Wang, Y. Huang, Y. Wang, and L. Wang, “Generalized autoencoder: A neural network framework for dimensionality reduction,” in IEEE Conference on Computer Vision and Pattern Recognition, CVPR Workshops. IEEE Computer Society, 2014, pp. 496-503. [Online]. Available: https://doi.org/10.1109/CVPRW.2014.79
[5] Y. Wang, H. Yao, and S. Zhao, “Auto-encoder based dimensionality reduction,” Neurocomputing, vol. 184, pp. 232-242, 2016. [Online]. Available: https://doi.org/10.1016/j.neucom.2015.08.104 [6]G. E. Hinton and R. R. Salakhutdinov, “Reducing the dimensionality of data with neural networks,” science, vol. 313, no. 5786, pp. 504-507, 2006.
[7] “Autoencoders based deep learner for image denoising,” Procedia Computer Science, vol. 171, pp. 1535-1541, 2020, third International Conference on Computing and Network Communications (CoCoNet'19).
[8] L. Gondara, “Medical image denoising using convolutional denoising autoencoders,” in IEEE International Conference on Data Mining Workshops, ICDM Workshops. IEEE Computer Society, 2016, pp. 241-246. [Online]. Available: https://doi.org/10.1109/ICDMW.2016.0041
[9] K. Cho, “Boltzmann machines and denoising autoencoders for image denoising,” in 1st International Conference on Learning Representations, ICLR Workshop, Y. Bengio and Y. LeCun, Eds., 2013. [Online]. Available: http://arxiv.org/abs/1301.3468
[10] A. Buades, B. Coll, and J. Morel, “A review of image denoising algorithms, with a new one,” Multiscale Model. Simul., vol. 4, no. 2, pp. 490-530, 2005. [Online]. Available: https://doi.org/10.1137/040616024
[11] K. Zeng, J. Yu, R. Wang, C. Li, and D. Tao, “Coupled deep autoencoder for single image super-resolution,” IEEE Trans. Cybern., vol. 47, no. 1, pp. 27-37, 2017. [Online]. Available: https://doi.org/10.1109/TCYB.2015.2501373
[12] P. Vincent, H. Larochelle, I. Lajoie, Y. Bengio, and P. Manzagol, “Stacked denoising autoencoders: Learning useful representations in a deep network with a local denoising criterion,” J. Mach. Learn. Res., vol. 11, pp. 3371-3408, 2010. [Online]. Available: https://dl.acm.org/doi/10.5555/1756006.1953039
[13] A. Morales-Forero and S. Bassetto, “Case study: A semi-supervised methodology for anomaly detection and diagnosis,” in 2019 IEEE International Conference on Industrial Engineering and Engineering Management (IEEM), 2019, pp. 1031-1037.
[14] M. Sakurada and T. Yairi, “Anomaly detection using autoencoders with nonlinear dimensionality reduction,” in Proceedings of the MLSDA 2014 2nd Workshop on Machine Learning for Sensory Data Analysis, A. Rahman, J. D. Deng, and J. Li, Eds. ACM, 2014, p. 4. [Online]. Available: https://doi.org/10.1145/2689746.2689747
[15] C. Zhou and R. C. Paffenroth, “Anomaly detection with robust deep autoencoders,” in Proceedings of the 23rd ACM SIGKDD International Conference on Knowledge Discovery and Data Mining, Halifax, NS, Canada, Aug. 13-17, 2017. ACM, 2017, pp. 665-674. [Online]. Available: https://doi.org/10.1145/3097983.3098052
[16] Z. Chen, C. K. Yeo, B. S. Lee, and C. T. Lau, “Autoencoder-based network anomaly detection,” in 2018 Wireless telecommunications symposium (WTS). IEEE, 2018, pp. 1-5. [Online]. Available: https://doi.org/10.1145/3097983.3098052
[17] D. Liang, R. G. Krishnan, M. D. Hoffman, and T. Jebara, “Variational autoencoders for collaborative filtering,” in Proceedings of the 2018 World Wide Web Conference. ACM, 2018, pp. 689-698. [Online]. Available: https://doi.org/10.1145/3178876.3186150
[18] N. Sachdeva, G. Manco, E. Ritacco, and V. Pudi, “Sequential variational autoencoders for collaborative filtering,” in Proceedings of the Twelfth ACM International Conference on Web Search and Data Mining, WSDM 2019. ACM, 2019, pp. 600-608. [Online]. Available: https://doi.org/10.1145/3289600.3291007
[19] S. Zhai and Z. Zhang, “Semisupervised autoencoder for sentiment analysis,” in Proceedings of the AAAI Conference on Artificial Intelligence, vol. 30, no. 1, 2016.
[20] H. Sagha, N. Cummins, and B. W. Schuller, “Stacked denoising autoencoders for sentiment analysis: a review,” WIREs Data Mining Knowl. Discov., vol. 7, no. 5, 2017. [Online]. Available: https://doi.org/10.1002/widm.1212
[21] C. Wu, F. Wu, S. Wu, Z. Yuan, J. Liu, and Y. Huang, “Semi-supervised dimensional sentiment analysis with variational autoencoder,” Knowl. Based Syst., vol. 165, pp. 30-39, 2019. [Online]. Available: https://doi.org/10.1016/j.knosys.2018.11.018
[22] O. Adigun and B. Kosko, “Bidirectional representation and backpropagation learning,” in International Joint Conference on Advances in Big Data Analytics, 2016, pp. 3-9.
[23]O. Adigun and B. Kosko, “Bidirectional backpropagation,” IEEE Transaction on Systems, Man, and Cybernetics: Systems, Man, and Cybernetics, 2018.
[24] L. Van der Maaten and G. Hinton, “Visualizing data using t-SNE.” Journal of machine learning research, vol. 9, no. 11, 2008.
[26] Z. Ma and A. Leijon, “Beta mixture models and the application to image classification,” in Proceedings of the International Conference on Image Processing, ICIP 2009, 7-10 Nov. 2009, Cairo, Egypt. IEEE, 2009, pp. 2045-2048. [Online]. Available: https://doi.org/10.1109/ICIP.2009.5414043
[27] G. Loaiza-Ganem and J. P. Cunningham, “The continuous bernoulli: fixing a pervasive error in variational autoencoders,” Advances in Neural Information Processing Systems, vol. 32, 2019.
[28] B. Kosko, K. Audhkhasi, and O. Osoba, “Noise can speed backpropagation learning and deep bidirectional pretraining,” Neural Networks, vol. 129, pp. 359-384, 2020. [29]B. Kosko, “Bidirectional associative memories,” IEEE Transactions on Systems, Man and Cybernetics, vol. 18, no. 1, pp. 49-60, 1988.
[30] O. Adigun and B. Kosko, “Noise-boosted bidirectional backpropagation and adversarial learning,” Neural Networks, vol. 120, pp. 9-31, 2019. [Online]. Available: https://doi.org/10.1016/j.neunet.2019.09.016
[31] B. Kosko, “Bidirectional associative memories: unsupervised hebbian learning to bidirectional backpropagation,” IEEE Transactions on Systems, Man, and Cybernetics: Systems, vol. 51, no. 1, pp. 103-115, 202].
[32] J. Devlin, M.-W. Chang, K. Lee, and K. Toutanova, “BERT: Pretraining of deep bidirectional transformers for language understanding,” arXiv preprint arXiv:1810.04805, 2018.
[33] O. Adigun and B. Kosko, “Deeper neural networks with nonvanishing logistic hidden units: NoVa vs. ReLU neurons,” in 2021 20th IEEE International Conference on Machine Learning and Applications (ICMLA), 2021, pp. 1407-1412. [Online]. Available: https://doi.org/10.1109/ICMLA52953.2021.00227
[34] O. Adigun and B. Kosko, “Deeper bidirectional neural networks with generalized non-vanishing hidden neurons,” in 21st IEEE International Conference on Machine Learning and Applications, ICMLA 2022. IEEE, 2022, pp. 69-76. [Online]. Available: https://doi.org/10.1109/ICMLA55696.2022.00017
[35] A. Krizhevsky, G. Hinton et al., “Learning multiple layers of features from tiny images,” Citeseer, Tech. Rep., 2009.
[36] Z. Wang, A. C. Bovik, H. R. Sheikh, and E. P. Simoncelli, “Image quality assessment: from error visibility to structural similarity,” IEEE transactions on image processing, vol. 13, no. 4, pp. 600-612, 2004.
[39] S. Sinha and A. B. Dieng, “Consistency regularization for variational auto-encoders,” in Advances in Neural Information Processing Systems 34: Annual Conference on Neural Information Processing Systems 2021, NeurIPS 2021, Dec. 6-14, 202], 2021, pp. 12 943-12 954.
[40] T. R. Davidson, L. Falorsi, N. D. Cao, T. Kipf, and J. M. Tomczak, “Hyperspherical variational auto-encoders,” in Proceedings of the Thirty-Fourth Conference on Uncertainty in Artificial Intelligence, UAI 2018, Monterey, USA, Aug. 6-10, 2018. AUAI Press, 2018, pp. 856-865.
[41] D. P. Kingma and M. Welling, “Auto-encoding variational bayes,” in 2nd International Conference on Learning Representations, ICLR 2014, Banff, AB, Canada, Apr. 14-16, 2014, 2014.
[42] I. Higgins, L. Matthey, A. Pal, C. Burgess, X. Glorot, M. Botvinick, S.
Mohamed, and A. Lerchner, “beta-vae: Learning basic visual concepts with a constrained variational framework,” in International conference on learning representations, 2016.
[43] R. T. Chen, X. Li, R. B. Grosse, and D. K. Duvenaud, “Isolating sources of disentanglement in variational autoencoders,” Advances in neural information processing systems, vol. 31, 2018.
[44] C. P. Burgess, I. Higgins, A. Pal, L. Matthey, N. Watters, G. Desjardins, and A. Lerchner, “Understanding disentangling in p-vae,” CoRR, vol. abs/1804.03599, 2018. [Online]. Available: http://arxiv.org/abs/1804.03599
[45] Y. Burda, R. Grosse, and R. Salakhutdinov, “Importance weighted autoencoders,” arXiv preprint arXiv:1509.00519, 2015.
[46] T. Rainforth, A. Kosiorek, T. A. Le, C. Maddison, M. Igl, F. Wood, and Y. W. Teh, “Tighter variational bounds are not necessarily better,” in International Conference on Machine Learning. PMLR, 2018, pp. 4277-4285.
[47] S. Zhao, J. Song, and S. Ermon, “Infovae: Information maximizing variational autoencoders,” arXiv preprint arXiv:1706.02262, 2017.
[48] A. L. Caterini, A. Doucet, and D. Sejdinovic, “Hamiltonian variational auto-encoder,” in Advances in Neural Information Processing Systems 31: NeurIPS 2018, Dec. 3-8, 2018, Montreal, Canada, 2018, pp. 8178-8188.
[49] P. Vincent, H. Larochelle, I. Lajoie, Y. Bengio, and P.-A. Manzagol, “Stacked denoising autoencoders: Learning useful representations in a deep network with a local denoising criterion,” Journal of Machine Learning Research, vol. 11, no. 110, pp. 3371-3408, 2010. [Online]. Available: http://jmlr.org/papers/vl1/vincent10a.html
[50] P. Smolensky et al., “Information processing in dynamical systems: Foundations of harmony theory,” 1986.
[51] B. Kosko, “Bidirectional associative memories,” IEEE Transactions on Systems, man, and Cybernetics, vol. 18, no. 1, pp. 49-60, 1988.
[52] G. E. Hinton and R. R. Salakhutdinov, “Reducing the dimensionality of data with neural networks,” science, vol. 313, no. 5786, pp. 504-507, 2006.
[53] H. Larochelle and Y. Bengio, “Classification using discriminative restricted boltzmann machines,” in Proceedings of the 25th international conference on Machine learning, 2008, pp. 536-543.
[54] O. Adigun and B. Kosko, “Bidirectional backpropagation autoencoding networks for image compression and denoising,” in 2023 International Conference on Machine Learning and Applications (ICMLA). IEEE, 2023, pp. 730-737.
[55] Y. LeCun, “The mnist database of handwritten digits,” http://yann.lecun.com/exdb/mnist/, 1998.
[56] H. Xiao, K. Rasul, and R. Vollgraf, “Fashion-mnist: a novel image dataset for benchmarking machine learning algorithms,” arXiv preprint arXiv:1708.07747, 2017.
[57] A. Krizhevsky, G. Hinton et al., “Learning multiple layers of features from tiny images,” 2009.
[58] Z. Liu, P. Luo, X. Wang, and X. Tang, “Deep learning face attributes in the wild,” in Proceedings of International Conference on Computer Vision (ICCV), December 2015.
[59] M. Heusel, H. Ramsauer, T. Unterthiner, B. Nessler, and S. Hochreiter, “Gans trained by a two time-scale update rule converge to a local nash equilibrium,” in Advances in Neural Information Processing Systems 30: Annual Conference on Neural Information Processing Systems 2017, Dec. 4-9, 2017, Long Beach, CA, USA, 2017, pp. 6626-6637.
[60] M. Fréchet, “Sur la distance de deux lois de probabilité,” in Annales de l'ISUP, vol. 6, no. 3, 1957, pp. 183-198.
[61] Z. Wang, A. C. Bovik, H. R. Sheikh, and E. P. Simoncelli, “Image quality assessment: from error visibility to structural similarity,” IEEE Transactions on Image Processing, vol. 13, no. 4, pp. 600-612, 2004.
[63] P. Ghosh, M. S. M. Sajjadi, A. Vergari, M. J. Black, and B. Schölkopf, “From variational to deterministic autoencoders,” in 8th International Conference on Learning Representations, ICLR 2020, Addis Ababa, Ethiopia, Apr. 26-30, 2020, 2020.
[64] Y. Burda, R. B. Grosse, and R. Salakhutdinov, “Importance weighted autoencoders,” in 4th International Conference on Learning Representations, ICLR 2016, San Juan, Puerto Rico, May 2-4, 2016, 2016.
[66], “Deeper neural networks with non-vanishing logistic hidden units: Nova vs. relu neurons,” in 2021 20th IEEE International Conference on Machine Learning and Applications (ICMLA). IEEE, 2021, pp. 1407-1412.
[67] V. Dumoulin and F. Visin, “A guide to convolution arithmetic for deep learning,” arXiv preprint arXiv:1603.07285, 2016.
[68] I. Loshchilov and F. Hutter, “Decoupled weight decay regularization,” arXiv preprint arXiv:171]. 05101, 2017.
[69] L. N. Smith and N. Topin, “Super-convergence: Very fast training of neural networks using large learning rates,” in Artificial intelligence and machine learning for multi-domain operations applications, vol. 11006. SPIE, 2019, pp. 369-386.
[70] C. Chadebec, L. J. Vincent, and S. Allassonniére, “Pythae: Unifying generative autoencoders in python—A benchmarking use case,” in NeurIPS, 2022.

What is claimed is:

1. A bidirectional autoencoder comprising:
a single bidirectional network for encoding and decoding wherein the encoding and decoding use the same synaptic weights, the single bidirectional network running as an encoder in a forward direction and as a decoder in a backward direction.

2. The bidirectional autoencoder of claim 1, wherein the single bidirectional network is a neural network.

3. The bidirectional autoencoder of claim 1, wherein the single bidirectional network includes a convolutional neural network.

4. The bidirectional autoencoder of claim 1, wherein a forward inference passes through a given rectangular weight matrix W while a backward inference passes through a matrix transpose W^{T}.

5. The bidirectional autoencoder of claim 1, wherein the bidirectional autoencoder learns or approximates an identity mapping from an input pattern space to a same or similar output pattern space.

6. The bidirectional autoencoder of claim 1 trained with a bidirectional backpropagation algorithm.

7. The bidirectional autoencoder of claim 6, wherein training maximizes a backward likelihood p(x|y, θ) of the single bidirectional network.

8. The bidirectional autoencoder of claim 7, wherein during training an error function ε_{M}(x, θ) is minimized.

9. The bidirectional autoencoder of claim 8, wherein the error function ε_{M}(x, θ) equals a negative log-likelihood of M training samples with an assumption of independent and identical distribution.

10. The bidirectional autoencoder of claim 1, wherein the bidirectional autoencoder is trained by a computer-implemented method comprising:
performing a forward pass through a bidirectional network to encode input data into a latent representation using a first set of synaptic weights;
performing a backward pass through the bidirectional network to decode the latent representation into reconstructed data using a transpose of the first set of synaptic weights; and
optimizing a training error function that incorporates forward likelihood and backward likelihood to enhance data reconstruction accuracy.

11. The bidirectional autoencoder of claim 1, wherein the bidirectional autoencoder is a bidirectional variational autoencoder.

12. The bidirectional autoencoder of claim 11, wherein the bidirectional variational autoencoder uses a single parametrized network for encoding and decoding.

13. The bidirectional autoencoder of claim 12, wherein the bidirectional variational autoencoder is trained with a bidirectional backpropagation algorithm that jointly optimizes a joint bidirectional likelihood.

14. The bidirectional autoencoder of claim 12, wherein the bidirectional variational autoencoder is trained by a method comprising:
receiving a dataset of input samples and defining a latent space dimension;
initializing synaptic weights for encoding and decoding, a learning rate, and other hyperparameters; and
iteratively performing steps 1)-4) comprising:
1) selecting a subset of samples from the dataset as a mini-batch;
2) predicting a variational mean from the input sample using a neural network and a log-variance from the input sample using the neural network;
3) sampling a latent variable by adding noise to the calculated mean scaled by the square root of the variance;
4) decoding the sampled latent variable to reconstruct an original input sample by reversing operation of the neural network;
estimating a training loss by:
a. Calculating a Kullback-Leibler divergence term to measure a difference between a variational distribution and a standard Gaussian distribution;
b. Calculating a reconstruction loss to measure a difference between a reconstructed input and the original input sample; and
c. Combining a divergence term and reconstruction loss into a total training loss; and
updating the synaptic weights by backpropagating gradients of the total training loss through the neural network.

15. The bidirectional autoencoder of claim 11, wherein the bidirectional variational autoencoder allow direct computation of ln p(xθ) wherein p(xθ) is a data likelihood.

16. The bidirectional autoencoder of claim 15, wherein the bidirectional variational autoencoder uses a single bidirectional network to model the encoding and decoding phases.

17. The bidirectional autoencoder of claim 16, wherein a forward-pass likelihood p(xz, θ) models the encoding and a backward-pass likelihood q(xz, θ) models the decoding.

18. A computing device configured to execute instructions for creating and/or training the bidirectional autoencoder of claim 1.

19. A method of training a bidirectional autoencoder, the bidirectional autoencoder including a single bidirectional network for encoding and decoding wherein the encoding and decoding use the same synaptic weights, the single bidirectional network running as an encoder in a forward direction and as a decoder in a backward direction, the method comprising:
performing a forward pass through a bidirectional network to encode input data into a latent representation using a first set of synaptic weights,
performing a backward pass through the bidirectional network to decode the latent representation into reconstructed data using a transpose of the first set of synaptic weights,
optimizing a training error function with an optimization process that incorporates forward likelihood and backward likelihood to enhance data reconstruction accuracy.

20. The method of claim 19, wherein the training error function minimizes a negative log-likelihood of the reconstructed data.

21. The method of claim 19, wherein the optimization process improves at least one performance metric selected from the group consisting of:
peak signal-to-noise ratio (PSNR), and
structural similarity index measure (SSIM).

22. The method of claim 19, wherein the forward pass and backward pass jointly optimize the bidirectional network for data compression and denoising.

23. A method for training a bidirectional variational autoencoder, the bidirectional variational autoencoder including a single bidirectional network for encoding and decoding wherein the encoding and decoding use the same synaptic weights, the single bidirectional network running as an encoder in a forward direction and as a decoder in a backward direction, the method comprising:
receiving a dataset of input samples and defining a latent space dimension;
initializing synaptic weights for encoding and decoding, a learning rate, and other hyperparameters; and
iteratively performing steps 1)-4) comprising:
1) selecting a subset of samples from the dataset as a mini-batch;
2) predicting a variational mean from the input sample using a neural network and a log-variance from the input sample using the neural network;
3) sampling a latent variable by adding noise to the calculated mean scaled by the square root of the variance;
4) decoding the sampled latent variable to reconstruct an original input sample by reversing operation of the neural network;
estimating a training loss by:
a. Calculating a Kullback-Leibler divergence term to measure a difference between a variational distribution and a standard Gaussian distribution;
b. Calculating a reconstruction loss to measure a difference between a reconstructed input and the original input sample; and
c. Combining a divergence term and reconstruction loss into a total training loss; and
updating the synaptic weights by backpropagating gradients of the total training loss through the neural network.

24. The method of claim 23, wherein the single bidirectional network is a single bidirectional neural network.

25. The method of claim 23, further comprising regularizing the latent space to improve generalization by enforcing a standard Gaussian distribution on the latent variables.

26. The method of claim 23, wherein the training loss is minimized using a gradient-based optimization algorithm.

27. The method of claim 23, wherein the method includes monitoring performance metrics, including reconstruction accuracy and divergence minimization, to evaluate training effectiveness.
